(19) United States
(12) Patent Application Publication
(10) Pub. No.: US 2026/0350780 A1
(43) Pub. Date: Nov. 5, 2026

(54) DEFECT DETECTION METHOD

(71) Applicant: Tencent Technology (Shenzhen) Company Limited, Shenzhen (CN)

(72) Inventor: Jiawei ZHAN, Shenzhen (CN)

(73) Assignee: Tencent Technology (Shenzhen) Company Limited, Shenzhen, GD (CN)

(21) Appl. No.: 19/538,844

(22) Filed: Feb. 12, 2026

Related U.S. Application Data
(63) Continuation of application No. PCT/CN2024/118110, filed on Sep. 11, 2024.

(30) Foreign Application Priority Data
Nov. 10, 2023 (CN) 202311498351.5

(51) Int. Cl. G06T 7/00; G06T 7/11; G06T 7/33; G06V 10/24; G06V 10/25; G06V 10/44; G06V 10/80; G06V 10/82

(52) U.S. Cl. CPC G06T 7/001; G06T 7/11; G06T 7/337; G06V 10/242; G06V 10/25; G06V 10/454; G06V 10/806; G06V 10/82; G06T 2207/10024; G06T 2207/20084; G06T 2207/20224; G06T 2207/30164

(57) ABSTRACT

In a defect detection method, a to-be-detected image of a target workpiece and a template image of the target workpiece are obtained, and a differential image is obtained based on a difference between the to-be-detected image and the template image. Defect detection is performed based on application of a defect detection model to the to-be-detected image and the differential image to obtain defect detection bounding box information in the to-be-detected image. Defect region information in the differential image is determined, and a first detection result of the target workpiece is determined based on the defect region information. A second detection result of the target workpiece is determined based on the defect detection bounding box information and the first detection result.

### RELATED APPLICATIONS

The present application is a continuation of International Application No. PCT/CN2024/118110, filed on Sep. 11, 2024, which claims priority to Chinese Patent Application No. 202311498351.5, filed on Nov. 10, 2023, and entitled “DEFECT DETECTION METHOD, DEVICE, ELECTRONIC EQUIPMENT, AND STORAGE MEDIUM.” The entire disclosures of the prior applications are hereby incorporated by reference.

### FIELD OF THE TECHNOLOGY

This disclosure relates to the field of artificial intelligence technologies, including a defect detection method and apparatus, an electronic device, a storage medium, and a program product.

### BACKGROUND OF THE DISCLOSURE

In some applications, product defect detection is usually implemented by using a deep learning algorithm. However, accuracy of defect detection performed by using the deep learning algorithm relies on a large quantity of manually labeled defect samples. A larger quantity of defect types or lower distinguishability of defect features indicates that a larger quantity of defect samples may be needed, leading to high costs of obtaining samples and low training efficiency. In addition, because supervised training is usually used in the deep learning algorithm, accuracy of defect detection may be reduced when training samples are insufficient.

### SUMMARY

Embodiments of this disclosure provide a defect detection method and apparatus, an electronic device, a storage medium, and a program product, to improve accuracy of defect detection and reduce dependency on a training sample.

According to an aspect, an embodiment of this disclosure provides a defect detection method. In the method, a to-be-detected image of a target workpiece and a template image of the target workpiece are obtained, and a differential image is obtained based on a difference between the to-be-detected image and the template image. Defect detection is performed by processing circuitry based on application of a defect detection model to the to-be-detected image and the differential image to obtain defect detection bounding box information in the to-be-detected image. Defect region information in the differential image is determined by the processing circuitry, and a first detection result of the target workpiece is determined based on the defect region information. A second detection result of the target workpiece is determined based on the defect detection bounding box information and the first detection result.

According to an aspect, an embodiment of this disclosure provides a defect detection apparatus that includes processing circuitry. The processing circuitry is configured to obtain a to-be-detected image of a target workpiece and a template image of the target workpiece and obtain a differential image based on a difference between the to-be-detected image and the template image. The processing circuitry is configured to perform defect detection based on application of a defect detection model to the to-be-detected image and the differential image to obtain defect detection bounding box information in the to-be-detected image. The processing circuitry is configured to determine defect region information in the differential image, and determine a first detection result of the target workpiece based on the defect region information. The processing circuitry is configured to determine a second detection result of the target workpiece based on the defect detection bounding box information and the first detection result.

According to an aspect, an embodiment of this disclosure provides a non-transitory computer-readable storage medium storing instructions, which when executed by a processor, cause the processor to perform a dialogue processing method. In the method, a to-be-detected image of a target workpiece and a template image of the target workpiece are obtained, and a differential image is obtained based on a difference between the to-be-detected image and the template image. Defect detection is performed based on application of a defect detection model to the to-be-detected image and the differential image to obtain defect detection bounding box information in the to-be-detected image. Defect region information in the differential image is determined, and a first detection result of the target workpiece is determined based on the defect region information. A second detection result of the target workpiece is determined based on the defect detection bounding box information and the first detection result.

According to an aspect, an embodiment of this disclosure provides a defect detection method, including: obtaining a to-be-detected image of a target workpiece and a template image of the target workpiece, and comparing the to-be-detected image with the template image to obtain a differential image; inputting the to-be-detected image and the differential image to a defect detection model, to perform the following processing: extracting a target image feature based on the to-be-detected image and the differential image; and performing defect detection on the to-be-detected image based on the target image feature to obtain defect detection bounding box information in the to-be-detected image; locating a defect region in the differential image, and determining a first detection result of the target workpiece based on the defect region; and determining a second detection result of the target workpiece based on the defect detection bounding box information and the first detection result.

According to another aspect, an embodiment of this disclosure further provides a defect detection apparatus, including: a first processing module, configured to obtain a to-be-detected image of a target workpiece and a template image of the target workpiece, and compare the to-be-detected image with the template image to obtain a differential image; a second processing module, configured to input the to-be-detected image and the differential image to a defect detection model, to perform the following processing: extracting a target image feature based on the to-be-detected image and the differential image; and performing defect detection on the to-be-detected image based on the target image feature to obtain defect detection bounding box information in the to-be-detected image; a third processing module, configured to locate a defect region in the differential image, and determine a first detection result of the target workpiece based on the defect region; and a fourth processing module, configured to determine a second detection result of the target workpiece based on the defect detection bounding box information and the first detection result.

According to another aspect, an embodiment of this disclosure further provides an electronic device, including a memory and processing circuitry (e.g., a processor), the memory (including, e.g., a non-transitory computer-readable storage medium) having a computer program stored therein, and the processor, when executing the computer program, implementing the foregoing defect detection method.

According to another aspect, an embodiment of this disclosure further provides a non-transitory computer-readable storage medium, the storage medium having a computer program stored therein, and the computer program, when executed by processing circuitry (e.g., a processor), implementing the foregoing defect detection method.

According to another aspect, an embodiment of this disclosure further provides a computer program product, the computer program product including a computer program, and the computer program being stored in a non-transitory computer-readable storage medium. Processing circuitry (e.g., a processor) of a computer device reads the computer program from the computer-readable storage medium, and the processor executes the computer program, to enable the computer device to perform the foregoing defect detection method.

### BRIEF DESCRIPTION OF THE DRAWINGS

The accompanying drawings are intended to provide a further understanding of the technical solutions of this disclosure, constitute a part of the specification, and are used to explain the technical solutions of this disclosure together with the embodiments of this disclosure, but do not constitute a limitation on the technical solutions of this disclosure.

FIG. 1 is a schematic diagram of an implementation environment according to an embodiment of this disclosure.

FIG. 2 is a schematic flowchart of a defect detection method according to an embodiment of this disclosure.

FIG. 3 is a schematic diagram of comparison between a to-be-detected image and a template image according to an embodiment of this disclosure.

FIG. 4 is a schematic diagram of generating defect detection bounding box information of a to-be-detected image according to an embodiment of this disclosure.

FIG. 5 is a schematic diagram of preprocessing before feature extraction is performed on a to-be-detected image and a differential image according to an embodiment of this disclosure.

FIG. 6 is a schematic diagram of a process of extracting a first image feature according to an embodiment of this disclosure.

FIG. 7 is a schematic diagram of generating a data stream of a convolutional branch in a process of extracting a first image feature according to an embodiment of this disclosure.

FIG. 8 is a schematic diagram of a process of extracting a first image feature according to another embodiment of this disclosure.

FIG. 9 is a schematic diagram of a process of extracting a first image feature according to another embodiment of this disclosure.

FIG. 10 is a schematic diagram of extracting a second target convolutional feature according to an embodiment of this disclosure.

FIG. 11 is a schematic diagram of a process of generating a target image feature according to an embodiment of this disclosure.

FIG. 12 is a schematic diagram of a defect detection process according to an embodiment of this disclosure.

FIG. 13 is a schematic diagram of a process of determining a second detection result according to an embodiment of this disclosure.

FIG. 14 is a schematic diagram of effect of morphological filtering according to an embodiment of this disclosure.

FIG. 15 is a schematic diagram of a process of determining a correlation coefficient according to an embodiment of this disclosure.

FIG. 16 is a schematic diagram of a similarity transformation correspondence between a template image and a to-be-detected image according to an embodiment of this disclosure.

FIG. 17 is a schematic diagram of a training process for a defect detection model according to an embodiment of this disclosure.

FIG. 18 is a schematic diagram of a defect detection process according to another embodiment of this disclosure.

FIG. 19 is a schematic diagram of a process of generating defect detection bounding box information according to another embodiment of this disclosure.

FIG. 20 is a schematic diagram of an overall process of a defect detection method according to an embodiment of this disclosure.

FIG. 21 is a schematic diagram of an overall process of a defect detection method according to an embodiment of this disclosure.

FIG. 22 is a schematic structural diagram of a defect detection apparatus according to an embodiment of this disclosure.

FIG. 23 is a block diagram of a partial structure of a terminal according to an embodiment of this disclosure.

FIG. 24 is a block diagram of a partial structure of a server according to embodiment of this disclosure.

### DESCRIPTION OF EMBODIMENTS

To describe the objectives, technical solutions, and advantages of this disclosure, this disclosure is described in further detail with reference to the accompanying drawings and the embodiments. The embodiments described herein are merely intended to explain this disclosure, and are not intended to limit this disclosure. Other embodiments are within the scope of this disclosure.

For ease of understanding of the technical solutions provided in the embodiments of this disclosure, some examples of key terms used in the embodiments of this disclosure are explained below first. The descriptions of the terms are provided as examples only and are not intended to limit the scope of the disclosure.

Defect detection is usually detection on a surface defect of an object. During surface defect detection, a machine vision detection technology is used to detect defects, such as a spot, a pit, a scratch, a color difference, and damage, on a surface of a workpiece, and a part with a defect may be identified.

Red-green-blue (RGB) is a color model including three primary colors: red, green, and blue. Various colors are obtained through changes in channels of the three colors, that is, red, green, and blue, and superposition thereof. In the fields of electronic displays, photography, computer graphics, and the like, the RGB is widely used to describe, control, and display a color image, and is used as a save format and a display format of a photo obtained through imaging by a camera.

Morphological image processing is a series of image processing technologies for processing an image shape feature. A basic idea of morphology is to measure or extract a corresponding shape or feature in an input image by using a special structural element, to further perform image analysis and object recognition.

Currently, product defect detection is usually implemented by using a deep learning algorithm. For example, in an industrial manufacturing scenario, technologies such as artificial intelligence and deep learning are usually used for quality inspection on an appearance of a product. When the deep learning algorithm is used for defect detection, a deep learning network model trained in a supervised manner is usually used to label a defect in an image of a workpiece under quality inspection, an abnormal region is recognized by using an object detection method or an object segmentation method, and then defects are classified, to achieve corresponding defect detection effect.

However, because the defect in the image of the workpiece under quality inspection needs to be manually labeled, sample manufacturing costs are high. In addition, a larger quantity of defect samples are needed with an increasing quantity of defect types or lower distinguishability of a defect feature. Moreover, it is difficult to obtain some samples with severe visual defects. Consequently, the deep learning algorithm has not learned features of similar defects, and cannot accurately distinguish a defect condition of the workpiece under quality inspection. Therefore, accuracy of defect detection performed by using the deep learning algorithm relies on a large quantity of manually labeled defect samples. However, difficulty and costs of obtaining samples are high. Consequently, accuracy of defect detection is reduced when samples are insufficient.

To resolve the foregoing problems, the embodiments of this disclosure provide a defect detection method and apparatus, an electronic device, a storage medium, and a program product, to improve accuracy of defect detection and reduce dependency on a training sample.

The method provided in the embodiments of this disclosure may be applied to different technical fields, including but not limited to the following scenarios: artificial intelligence, cloud technologies, computer vision technologies, industrial automation, and the like.

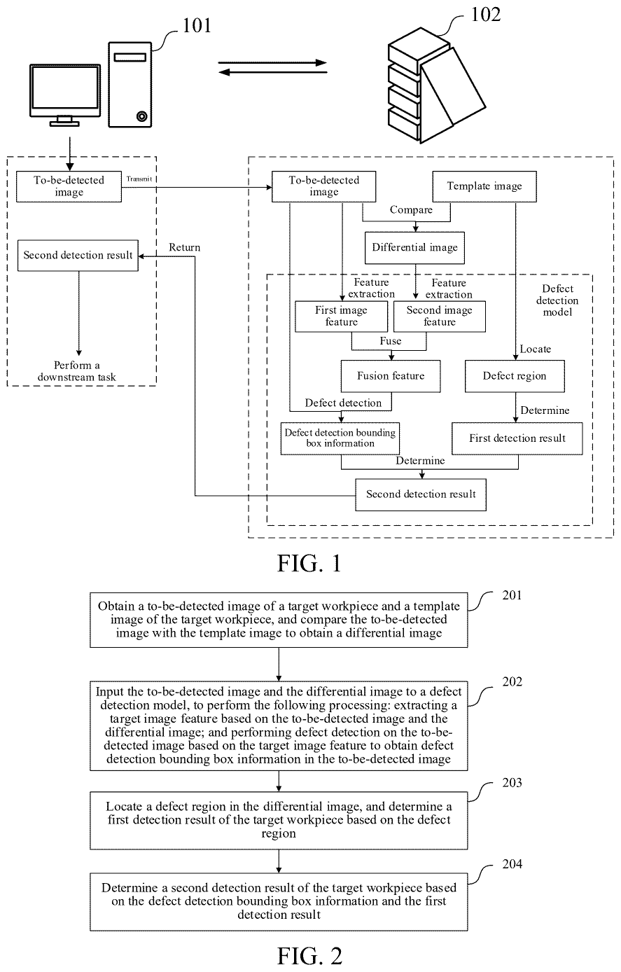

FIG. 1 is a schematic diagram of an implementation environment according to an embodiment of this disclosure. The implementation environment includes a terminal 101 and a server 102. The terminal 101 is connected to the server 102 through a communication network.

The terminal 101 may be a smartphone, a tablet computer, a notebook computer, a desktop computer, a smart speaker, a smartwatch, an in-vehicle terminal, or the like, but is not limited thereto. The terminal 101 and the server 102 may be directly or indirectly connected through wired or wireless communication. This is not limited in this embodiment of this disclosure. In some embodiments, the terminal 101 may obtain a to-be-detected image of a target workpiece, and then transmit the to-be-detected image to the server 102.

The server 102 may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In addition, the server 102 may alternatively be a node server in a blockchain network. In some embodiments, a defect detection model may be prestored on the server 102. The server 102 may further prestore a template image of the target workpiece, or the server 102 may receive a template image of the target workpiece that is transmitted by the terminal 101.

When obtaining the to-be-detected image of the target workpiece and the template image of the target workpiece, the server 102 may compare the to-be-detected image with the template image to obtain a differential image, and then separately input the to-be-detected image and the differential image to the prestored defect detection model to obtain defect detection bounding box information in the to-be-detected image; and may further locate a defect region in the differential image, determine a first detection result (namely, a reference detection result) of the target workpiece based on the defect region, and then determine a second detection result (namely, an object detection result) of the target workpiece based on the defect detection bounding box information and reference defect detection information.

In this way, differential comparison is combined with a deep learning algorithm, so that a feature with high visibility can be obtained through differential comparison, to visually assist in defect detection, effectively improve accuracy of defect detection, and reduce dependency on a training sample.

For example, the terminal 101 may obtain a to-be-detected image of a target workpiece and a template image of the target workpiece, and then transmit the to-be-detected image and the template image to the server 102. After receiving the to-be-detected image and the template image of the target workpiece, the server 102 may compare the to-be-detected image with the template image to obtain a differential image, where the differential image can provide visual difference information of the target workpiece. Then the server 102 separately inputs the to-be-detected image and the differential image to a defect detection model to extract a target image feature. Difference information is introduced into the defect detection model, to improve prediction accuracy of the model and improve reliability of the target image feature.

Then the server 102 performs defect detection on the to-be-detected image based on the target image feature, to obtain defect detection bounding box information in the to-be-detected image. A feature related to a defect region in the to-be-detected image is highlighted by using the differential image, to improve a capability of detecting, by the defect detection model, a defect category that has not been learned due to lack of a training sample, and improve accuracy of the defect detection bounding box information.

Then the server 102 locates a defect region in the differential image, determines a first detection result of the target workpiece based on the defect region, and determines a second detection result of the target workpiece based on the first detection result and the defect detection bounding box information. In this way, high visibility of a feature obtained through comparison can visually assist in defect detection, to effectively improve accuracy of defect detection and reduce dependency on a training sample.

FIG. 2 is a schematic flowchart of a defect detection method according to an embodiment of this disclosure. The defect detection method may be performed by a terminal, a server, or a terminal and a server in cooperation. In this embodiment of this disclosure, an example in which the method is performed by a server is used for description. The defect detection method includes but is not limited to the following operation 201 to operation 204.

Operation 201: Obtain a to-be-detected image of a target workpiece and a template image of the target workpiece, and compare the to-be-detected image with the template image to obtain a differential image.

In a possible implementation, the to-be-detected image of the target workpiece may be captured by a camera or a sensor, and the to-be-detected image may be a surface image, a cross-sectional image, an image obtained through infrared imaging, or the like of the target workpiece. This specifically depends on an object of defect detection and a detection requirement.

The template image of the target workpiece may be a reference image, to be specific, may be an image including a known normal or non-defective workpiece, and is configured for comparison with the to-be-detected image, to detect a difference or a defect on the target workpiece. The template image may be pre-obtained in a design or manufacturing process of a workpiece of the same category as that of the target workpiece.

Specifically, for surface defect detection, a camera may be used to obtain a surface image of the target workpiece, and the to-be-detected image may be an image from a front view, a side view, or another angle of the target workpiece, to comprehensively capture features of a surface of the workpiece.

For internal defect detection or cross-sectional detection, a sensor (for example, an X-ray sensor or an infrared sensor) may be used to obtain an internal structural image or a cross-sectional image of the target workpiece as the to-be-detected image.

Defect detection may be applied to a plurality of scenarios, for example, steel plate defect detection, floor blemish detection, printed circuit board (PCB) defect detection, thin film defect detection, lamp bead defect detection, metal bar end-face detection, and cloth wrinkle level evaluation. The target workpiece is correspondingly a steel plate, a floor, a PCB, thin film, a lamp bead, a metal bar, cloth, or the like.

In a possible implementation, during defect detection, the to-be-detected image may be compared with the template image, to find a difference and a change between the two images, and generate a differential image, so that a possible defect or abnormal condition on the target workpiece can be visually determined.

Color modes of the to-be-detected image and the template image of the target workpiece may be the same or different. Specifically, both the to-be-detected image and the template image of the target workpiece may be RGB color images. In this case, before the to-be-detected image is compared with the template image, grayscale conversion needs to be performed on the two images. Alternatively, the to-be-detected image of the target workpiece may be an RGB color image, and the template image may be a prestored grayscale binary image. In this case, before the to-be-detected image is compared with the template image, grayscale conversion needs to be performed only on the to-be-detected image.

Specifically, grayscale transformation may be separately performed on the to-be-detected image and the template image of the target workpiece, including: calculating a grayscale difference between a current pixel and an adjacent pixel in the image to obtain a pixel difference value; then comparing the pixel difference value with a preset grayscale difference threshold to obtain a binary pixel value of the current pixel; and then traversing pixels in the image to obtain binary pixel values of all pixels. The adjacent pixel may be a pixel around each pixel in the image, or may be all pixels in the image, or may be pixels, in images of different scales, that correspond to a position of the current pixel.

The to-be-detected image and the template image are converted into images of a binary image type. To be specific, the to-be-detected image and the template image are converted into grayscale images. A grayscale level of an image indicates a luminance value of each pixel in the image, and a higher grayscale level indicates higher luminance of the pixel. After the grayscale images corresponding to the to-be-detected image and the template image are obtained, comparison may be performed between the grayscale images. First, image matching is performed on the two images, and morphological processing, such as rotation, translation, and stretching, is performed on the template image to align a target workpiece displayed in the template image with a target workpiece displayed in the to-be-detected image. Then image comparison is performed on the to-be-detected image and an adjusted template image. To be specific, subtraction is performed between corresponding pixel values of the to-be-detected image and the adjusted template image, to reduce similar parts between the two images and highlight a changed part between the two images.

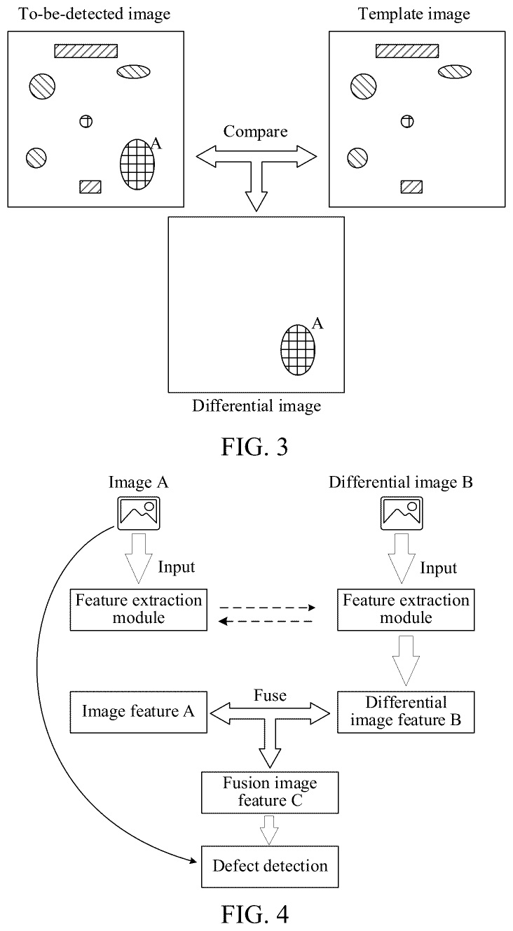

FIG. 3 is a schematic diagram of comparison between a to-be-detected image and a template image according to an embodiment of this disclosure. An absolute value obtained through subtraction between a pixel value of each pixel in the to-be-detected image and a pixel value of a corresponding pixel in the adjusted template image is used as a pixel value of each pixel in the differential image. A calculation formula is specifically as follows:

Df(x,y)=abs[I(x,y)−T(x,y)] (1)

Df(x, y) indicates a pixel value of a pixel with coordinates (x, y) in the differential image, I(x, y) indicates a pixel value of a pixel with coordinates (x, y) in the to-be-detected image, and T(x, y) indicates a pixel value of a pixel with coordinates (x, y) in the adjusted template image.

As shown in FIG. 3, a differential region A is displayed in the differential image, indicating that a difference occurs between the to-be-detected image and the adjusted template image. It can be found through comparison between the adjusted template image and the to-be-detected image that a structural region corresponding to the differential region A is displayed in the adjusted template image, and no structural region corresponding to the differential region A is displayed in the to-be-detected image. To be specific, a reference workpiece of the same category as that of the target workpiece has a first structure at a corresponding position in the differential region A, and the target workpiece does not have the first structure at the corresponding position in the differential region A.

In a possible implementation, the template image may be prestored on a server or a terminal. After the to-be-detected image of the target workpiece is obtained, object detection is performed on the target workpiece in the to-be-detected image to determine a workpiece category corresponding to the target workpiece, and then a template image of the same workpiece category is obtained based on the corresponding workpiece category as the template image of the target workpiece.

Operation 202: Input the to-be-detected image and the differential image to a defect detection model, to perform the following processing: extracting a target image feature based on the to-be-detected image and the differential image; and performing defect detection on the to-be-detected image based on the target image feature to obtain defect detection bounding box information in the to-be-detected image. For example, a differential image is obtained based on a difference between the to-be-detected image and the template image. Moreover, defect detection is performed by processing circuitry based on application of a defect detection model to the to-be-detected image and the differential image to obtain defect detection bounding box information in the to-be-detected image.

In a possible implementation, the defect detection model may be a neural network model that is constructed based on a deep learning algorithm and that is configured to automatically detecting and recognizing a defect of a workpiece. The defect detection model can learn and extract a feature from an input sample image, and predict and classify a defect based on the extracted feature.

The defect detection model is trained through supervised training. To be specific, a large quantity of labeled datasets are needed for training, performance and accuracy of the defect detection model depend on quality and a quantity of training data, and it is difficult for the defect detection model to detect a defect category that has not been learned. Therefore, in addition to inputting the to-be-detected image to the defect detection model for defect detection, the differential image is further inputted to the defect detection model, and the defect detection model can extract the target image feature based on both the to-be-detected image and the differential image.

The differential image is obtained through comparison between the to-be-detected image and the template image, and includes difference information between the two images. Therefore, the differential image is introduced to provide image difference information for the defect detection model, to assist the defect detection model in extracting a feature of the to-be-detected image. In this way, a feature of a corresponding region in the to-be-detected image can be more accurately extracted based on the image difference information, to help improve accuracy of subsequent defect detection.

In a possible implementation, a defect detection bounding box may be a rectangular box for marking and locating a defect region in the to-be-detected image, and the defect detection bounding box information may be position coordinates of the defect detection bounding box in the to-be-detected image, and may further include a confidence level outputted by the defect detection model for the defect detection bounding box.

The to-be-detected image may not clearly indicate a defect, but the differential image has high visibility and can highlight a feature with a visually clear defect in the to-be-detected image, so that the obtained target image feature can help improve sensitivity of the defect detection model to a visually clear defect. In addition, the defect detection model is obtained through supervised training, and the target image feature can supplement the difference information between the to-be-detected image and the template image, so that the defect detection model has a good capability of detecting a defect that has not been learned, to improve a generalization capability of the defect detection model.

Therefore, defect detection is performed on the to-be-detected image based on the target image feature, so that the defect detection model can recognize a defect that has a quite small size, is visually unclear, or is similar to a background, to improve detection precision. This can help reduce a false detection rate for a normal workpiece and a missing detection rate for a workpiece with a defect, and can also help the defect detection model recognize a defect feature that has not been learned in the to-be-detected image, to improve accuracy of generating a defect detection bounding box, in other words, improve reliability of the defect detection bounding box information.

In a possible implementation, in a process of inputting the to-be-detected image and the differential image to the defect detection model to extract the target image feature, a first image feature may be first extracted from the to-be-detected image, a second image feature is extracted from the differential image, and the first image feature and the second image feature are fused to obtain the target image feature.

In a possible implementation, feature fusion may include weighted fusion, feature concatenation, feature superposition, feature selection, and the like.

Specifically, a first weight may be allocated to the first image feature, a second weight is allocated to the second image feature, and then weighted summation is performed on the first image feature and the second image feature to obtain the target image feature. Selection of the first weight and the second weight may be determined based on importance of a features, or may be obtained through model training.

Specifically, the first image feature and the second image feature may alternatively be concatenated in a preset order to form a larger vector, so that information of the two features can be conveniently integrated to extend dimensionality of a feature vector. In this way, the defect detection model can use both a feature of the to-be-detected image and a feature of the differential image, to improve performance of the defect detection model.

Specifically, the first image feature and the second image feature may alternatively be superposed through addition and subtraction, a multiplication operation, a convolution operation, a pooling operation, or the like, to obtain the target image feature.

Region selection may alternatively be performed on the first image feature and the second image feature, to separately select some key feature information from the first image feature and some key feature information from the second image feature for re-combination, to form the target image feature.

The first image feature of the to-be-detected image captures original information of the target workpiece, and the second image feature of the differential image captures difference information between the target workpiece and the reference workpiece (a workpiece displayed in the template image of the target workpiece), that is, possible defect information of the target workpiece. The first image feature and the second image feature are fused to more comprehensively and accurately indicate information of the target workpiece. This helps improve accuracy of recognizing a defect in a subsequent defect detection operation.

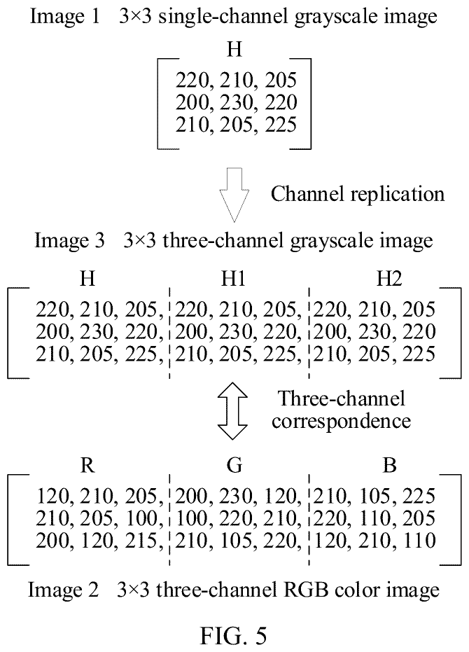

FIG. 4 is a schematic diagram of generating defect detection bounding box information of a to-be-detected image according to an embodiment of this disclosure. First, the to-be-detected image (an image A) and the differential image (a differential image B) of the target workpiece are obtained. Then feature extraction is separately performed on the image A and the differential image B by using a feature extraction module in the defect detection model, to obtain an image feature A (namely, the first image feature) of the image A and a differential image feature B (namely, the second image feature) of the differential image B. Then feature fusion is performed on the image feature A and the image feature B to obtain a target image feature C. Then defect detection may be performed on the image A based on the target image feature C, to obtain defect detection bounding box information of the image A.

The differential image feature B (namely, the second image feature of the differential image) is introduced, so that the defect detection model can better focus on a difference between the target workpiece and the reference workpiece. In this way, a defect that may be originally hidden in background noise or a surface texture is more likely to be detected, to improve sensitivity of the defect detection model to a defect, and further improve accuracy of the defect detection bounding box information.

In addition, feature extraction modules for extracting features of the image A and the differential image B may be different, and the two feature extraction modules may be separately obtained through training by using corresponding training samples. For example, if the image A is a color image, a feature extraction module for extracting a feature of the to-be-detected image (the image A) may use a color image as a training sample for feature extraction training; and if the differential image B is a grayscale image, a feature extraction module for extracting a feature of the differential image B may use a grayscale image as a training sample for feature extraction training, so that more accurate image features can be extracted for different image data.

In addition, parameters of feature extraction modules for extracting features of the image A and the differential image B may be the same, that is, the two images share a same feature extraction module, so that the feature extraction module of the defect detection model can learn two different types of information at the same time, and more accurately capture difference information between the two images.

Operation 203: Locate a defect region in the differential image, and determine a first detection result of the target workpiece based on the defect region. For example, defect region information in the differential image is determined by the processing circuitry; and a first detection result of the target workpiece is determined based on the defect region information. In some examples, Operation 203 is based on one or more of Boolean image processing, morphological image processing, and statistic processing of the differential image.

In a possible implementation, a pixel value of each pixel in the differential image may be compared with a preset pixel threshold, and when the pixel value of the pixel exceeds the preset pixel threshold, it can be considered that a defect occurs at a position corresponding to the pixel. The defect region in the differential image may be located through statistics collection on pixels with pixel values exceeding the preset pixel threshold.

In a possible implementation, the differential image may be a grayscale image. A connected-region analysis may be performed on the differential image, and adjacent pixels with a same pixel value are grouped into one connected region. The adjacent pixels may be foreground pixels. To be specific, adjacent pixels whose pixel values are 1 are grouped into one connected region. Then position information and size information of the defect region are determined by calculating a bounding rectangle, a minimum circumscribed circle, or the like of the connected region. For example, the bounding rectangle of the connected region may be calculated, and the bounding rectangle is used as the defect region.

In a possible implementation, a shape feature (for example, an aspect ratio or circularity) of the connected region may be further calculated to check whether the defect region conforms to a defect feature, to select a defect region conforming to the defect feature, and determine the first detection result.

In addition, before connected-region analysis is performed on the differential image, morphological processing (for example, an opening operation or a closing operation) may be first performed on the differential image to reduce impact of noise, and a connected region is filtered based on a preset connected-region threshold (for example, an area of the connected region or a perimeter of the connected region), to exclude a connected region with few pixels, and improve accuracy of analysis.

In a possible implementation, after the defect region is determined, whether the defect region meets a defect feature condition may be determined, to determine the first detection result of the target workpiece. To be specific, the first detection result is configured for indicating to determine, based on the differential image, whether the target workpiece has a defect.

Specifically, the defect feature condition may be: whether an area, a perimeter, or a shape of the defect region or a difference between a pixel value of a pixel in the connected region and a pixel value of a pixel outside the connected region exceeds a preset defect threshold. If the defect region meets one or more defect feature conditions, it can be considered that the target workpiece has a defect, that is, the first detection result is that quality inspection fails. If the defect region does not meet the defect feature condition, it can be considered that the target workpiece has no defect, that is, the first detection result is that quality inspection succeeds.

Operation 204: Determine a second detection result of the target workpiece based on the defect detection bounding box information and the first detection result.

In a possible implementation, the defect detection bounding box information includes a region, in the to-be-detected image, that possibly has a defect and that is predicted by the defect detection model based on a feature learned during training. The first detection result is configured for indicating a defect status of the target workpiece that is obtained by comparing the template image with the to-be-detected image, and has high visibility. This can avoid missing a defect that has not occurred during training but is visually clear. In addition, a recall rate for a known defect is high, so that detection accuracy can be effectively improved.

In addition, a computer vision technology is prone to interference from a lighting condition, a surface texture of a workpiece, and other factors, and it may be difficult to identify some defects in a single viewing angle or dimension. However, a combination of a plurality of information sources can reduce impact of the interference factors, to improve detection stability and reliability, so that a defect can be more comprehensively and accurately detected. Therefore, the second detection result may be determined based on both the defect detection bounding box information and the first detection result, to effectively reduce false detection and missing detection, and further improve accuracy of object defect detection and reduce dependency on a training sample.

In a possible implementation, whether the quality inspection of the target workpiece succeeds may be determined by comparing the defect detection bounding box information with a preset defect region condition. For example, the preset defect condition may be that an area of a defect detection bounding box indicated by the defect detection bounding box information is greater than a preset defect area, or that a defect detection bounding box indicated by the defect detection bounding box information includes a region in which no defect is allowed (for example, a structural region severely affecting workpiece quality). Therefore, when the defect detection bounding box information or the first detection result indicates that the quality inspection of the target workpiece fails, it can be determined that a defect of the target workpiece fails the quality inspection, that is, the second detection result is that the quality inspection fails. When both the defect detection bounding box information and the first detection result indicate that the quality inspection of the target workpiece succeeds, it can be determined that the target workpiece has no defect or a defect can succeed in the quality inspection, that is, the second detection result is that the quality inspection succeeds.

In a possible implementation, in a process of separately inputting the to-be-detected image and the differential image to the defect detection model, data of each channel in the differential image may be first replicated until a quantity of channels of a differential image obtained through replication is equal to a quantity of channels of the to-be-detected image; and the to-be-detected image and the differential image obtained through replication are separately inputted to the defect detection model, the to-be-detected image and the differential image obtained through replication sharing a same feature extraction module in the defect detection model. For example, an expanded differential image is obtained based on replicating data of the differential image, where a quantity of channels of the expanded differential image is equal to a quantity of channels of the to-be-detected image, and a quantity of channels of the differential image is less than the quantity of channels of the to-be-detected image. In addition, the to-be-detected image and the expanded differential image are separately input to the defect detection model.

The to-be-detected image and the differential image both include key information that helps recognize a defect. To enable the defect detection model to obtain more information for more accurate prediction, the to-be-detected image and the differential image may be inputted to a same feature extraction module for feature extraction. However, the feature extraction module requires that all inputs have same dimensionality.

FIG. 5 is a schematic diagram of preprocessing before feature extraction is performed on a to-be-detected image and a differential image according to an embodiment of this disclosure. In this case, for example, the differential image (an image 1) is a 3×3 grayscale image, the image 1 is a single-channel image and is represented by a matrix H. Each element in the matrix H corresponds to one pixel in the image, and each element is represented as luminance. A value range of each element may be 0 to 255.

The to-be-detected image is a color image and has multi-channel three-dimensional data. For example, the to-be-detected image (an image 2) is a three-channel 3×3 RGB color image. In the matrix, data of a channel R represents a component of a red channel, data of a channel G represents a component of a green channel, and data of a channel B represents a component of a blue channel.

Therefore, a quantity of channels of the differential image may be made to be equal to a quantity of channels of the to-be-detected image through replication. As shown in FIG. 5, the differential image (the image 1) is replicated into an image (an image 3) with three-channel data, where data of a channel H1, data of a channel H2, and data of a channel H are the same.

The differential image and the to-be-detected image share a same feature extraction module in the defect detection model, so that the defect detection model can process and learn, in same parameter space, information represented in two different manners, to implicitly provide difference information about the target workpiece for the model, and further improve performance of the defect detection model. In addition, the feature extraction module repeatedly uses a same group of neural network weights, without separately processing or learning a group of weights for each input, to reduce dependency on a training sample and improve training efficiency.

In a possible implementation, in a process of extracting the first image feature of the to-be-detected image, convolution may be first sequentially performed on the to-be-detected image in a plurality of stages, where
each stage includes at least one convolutional branch, and each convolutional branch is configured to perform convolution for a plurality of times;
a new convolutional branch is added upon entering a next stage from a current stage, and a resolution of the new convolutional branch is less than that of any existing convolutional branch in the current stage; and
a feature inputted to any convolutional branch in the current stage is obtained by fusing features outputted by all convolutional branches in a previous stage.

Then initial convolutional features outputted by convolutional branches in a last stage are fused to obtain a first target convolutional feature.

Then the first target convolutional feature is downsampled to obtain the first image feature.

First, convolution is performed on the to-be-detected image in the plurality of stages. Convolution is performed for a plurality of times during convolution in each stage. During the first convolution, only low-level features such as lines or edges of a target object (for example, a structure of the target workpiece) in an image can be extracted. With addition of convolution stages, deeper features, for example, high-level features such as a texture and a shape of the target object in the image, can be effectively extracted. This helps the defect detection model understand, in depth, specific content displayed in the to-be-detected image, to more accurately perform defect detection. In addition, during the plurality of times of convolution, a space size of an image can be effectively reduced, to reduce an amount of data for subsequent calculation.

After a high-level image feature is obtained, a new convolutional branch may be added. A resolution of the added convolutional branch is less than a resolution of any existing convolutional branch in a stage to which the added convolutional branch belongs, and an input for any existing convolutional branch in the stage to which the added convolutional branch belongs is obtained by fusing outputs of all convolutional branches in a previous stage.

By adding a convolutional branch with a smaller resolution, a feature that is of greater global significance or is more abstract can be detected based on an extracted feature, to gradually capture higher-level semantic information. In addition, noise in a feature can be reduced in the new convolutional branch, to improve reliability of the feature.

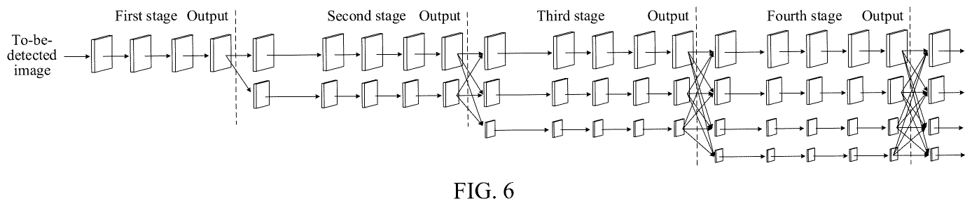

Specifically, FIG. 6 is a schematic diagram of a process of extracting a first image feature according to an embodiment of this disclosure. The process of extracting the first image feature of the to-be-detected image is implemented through parallel convolutional streams and has a plurality of stages. Starting from the first stage, data streams are gradually added from a high resolution to a low resolution. Resolutions of parallel data streams in a later stage include a resolution in a previous stage and a lower resolution. With a continuous increase in a quantity of stages, a quantity of different resolutions increases.

As shown in FIG. 6, a new convolutional branch is a data stream with a lowest resolution in a current stage to which the new convolutional branch belongs. An input for the new convolutional branch is obtained by downsampling features outputted by all convolutional branches in a previous stage. If there are a plurality of convolutional branches in the previous stage, features outputted by all the convolutional branches may be downsampled, to obtain features whose resolutions are the same as a resolution of the to-be-added convolutional branch. Then the features with the same resolution are fused (for example, through weighted fusion, concatenation, or superposition) to serve as an input for the new convolutional branch. In this way, a convolutional branch with a lower resolution is introduced, to obtain an image feature with a lower resolution.

In one example, the application of the defect detection model to the to-be-detected image and the differential image includes performing convolution in a plurality of stages. In this example, each stage incudes at least one convolutional branch, and each convolutional branch is configured to perform convolution for a plurality of times. In this example, a first stage of the plurality of stages including one convolutional branch taking the to-be-detected image as input. For each stage of the plurality of stages after the first stage, a new convolutional branch is added upon entering a next stage from the respective stage, a resolution of the new convolutional branch being less than that of any existing convolutional branch in the respective stage, and a feature inputted to each convolutional branch in the respective stage being obtained by fusing features outputted by all convolutional branches in a previous stage. In this example, the application of the defect detection model to the to-be-detected image and the differential image includes fusing initial convolutional features outputted by the convolutional branches in a last stage of the plurality of stages, to obtain a first target convolutional feature; and downsampling the first target convolutional feature to obtain the first image feature.

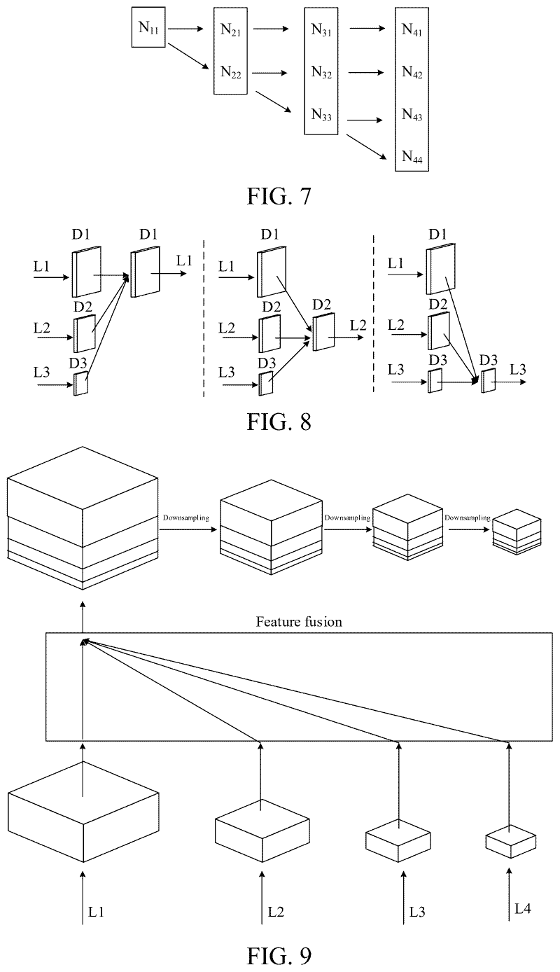

FIG. 7 is a schematic diagram of generating a data stream of a convolutional branch in a process of extracting a first image feature according to an embodiment of this disclosure. The extraction process shown in FIG. 7 corresponds to the extraction process shown in FIG. 6. The process of extracting the first image feature of the to-be-detected image may be divided into four stages.

A first stage includes one data stream N11 corresponding to one resolution. The resolution is a resolution (a first resolution) of an original convolutional branch for performing convolution on the to-be-detected image.

A second stage includes two data streams corresponding to two resolutions, including a data stream N₂₁ with the first resolution and a data stream N₂₂ with a resolution (a second resolution) lower than the first resolution. The second resolution is less than the first resolution.

By analogy, a third stage includes three data streams N₃₁, N₃₂, and N₃₃ corresponding to three resolutions, and a fourth stage includes four data streams N₄₁, N₄₂, N₄₃, and N₄₄ corresponding to four resolutions. In this way, a convolutional branch with a lower resolution is introduced, to obtain an image feature with a lower resolution.

When a new convolutional branch is added to a new convolution stage, features outputted by existing convolutional branches in a previous stage are correspondingly upsampled or downsampled, and added to an input for current convolution of a corresponding convolutional branch, so that an original feature learning path in the previous stage can be retained, and features at different resolution levels can be fused, to exchange feature information with different resolutions.

Specifically, FIG. 8 is a schematic diagram of a process of extracting a first image feature according to another embodiment of this disclosure. If a resolution of a current to-be-sampled convolutional branch is less than a resolution of a target convolutional branch, an output of the current to-be-sampled convolutional branch in a previous stage is upsampled to obtain an upsampling feature whose resolution is the same as the resolution of the target convolutional branch, and then the upsampling feature is used as an input for the target convolutional branch in a current stage, so that the target convolutional branch performs convolution on the upsampling feature.

If a resolution of a current to-be-sampled convolutional branch is greater than a resolution of a target convolutional branch, an output of the current convolutional branch in a previous stage is downsampled to obtain a downsampling feature whose resolution is the same as the resolution of the target convolutional branch, and then the downsampling feature is used as an input for the target convolutional branch in a current stage, so that the target convolutional branch performs convolution on the downsampling feature.

When N× downsampling is needed, sampling may be performed to a needed resolution through a plurality of times of downsampling.

If a resolution of a current to-be-sampled convolutional branch is equal to a resolution of a target convolutional branch, an output of the current to-be-sampled convolutional branch in a previous stage is retained as an input for the convolutional branch (the target convolutional branch) in a current stage, or an output of the current to-be-sampled convolutional branch in a previous stage is resampled as an input for the convolutional branch (the target convolutional branch) in a current stage.

As shown in FIG. 8, a first resolution D1 is greater than a second resolution D2, and the second resolution D2 is greater than a third resolution D3.

If the resolution of the target convolutional branch is the first resolution D1, a convolutional branch L1 corresponding to the first resolution may directly add a convolutional feature outputted by the convolutional branch in a previous stage to an input in a current stage; and a convolutional branch L2 corresponding to the second resolution D2 and a convolutional branch L3 corresponding to the third resolution need to upsample convolutional features outputted by the convolutional branches in the previous stage to the first resolution D1, and add the convolutional features to the input for the convolutional branch L1 in the current stage.

If the resolution of the target convolutional branch is the second resolution D2, a convolutional branch L1 corresponding to the first resolution needs to downsample a convolutional feature outputted by the convolutional branch in a previous stage to the second resolution D2, and add the convolutional feature to an input for a convolutional branch L2 in a current stage; the convolutional branch L2 corresponding to the second resolution may directly add a convolutional feature outputted by the convolutional branch in the previous stage to the input in the current stage; and a convolutional branch L3 corresponding to the third resolution needs to upsample a convolutional feature outputted by the convolutional branch in the previous stage to the second resolution D2, and add the convolutional feature to the input for the convolutional branch L2 in the current stage.

If the resolution of the target convolutional branch is the third resolution D3, a convolutional branch L1 corresponding to the first resolution and a convolutional branch L2 corresponding to the second resolution D2 need to downsample convolutional features outputted by the convolutional branches in a previous stage to the third resolution D3, and add the convolutional features to an input for a convolutional branch L3 in a current stage; and the convolutional branch L3 corresponding to the third resolution may directly add a convolutional feature outputted by the convolutional branch in the previous stage to the input in the current stage.

Therefore, when convolution starts in each stage, feature fusion is first performed on data currently inputted to each convolutional branch, to reduce an amount of data to be processed.

Multi-resolution fusion is repeatedly performed by repeatedly exchanging information in parallel data streams, to implement parallel concatenation and synchronous proceeding between a high resolution and a low resolution. In addition, information is continuously exchanged between a high-resolution feature and a low-resolution feature. An extracted high-resolution feature can make the first image feature more accurate in space in a subsequent feature fusion operation, and an extracted low-resolution feature can make the first image feature more semantically abundant in the subsequent feature fusion operation.

In a possible implementation, in a process of fusing the initial convolutional features outputted by the convolutional branches in the last stage to obtain the first target convolutional feature, a plurality of initial convolutional features may be first fused to obtain a fusion feature; for each of a plurality of convolutional branches in the last stage, convolution with a resolution the same as that of the convolutional branch is performed on the fusion feature to obtain a second target convolutional feature of the convolutional branch; and a plurality of second target convolutional features are fused to obtain the first target convolutional feature.

The plurality of second target convolutional features with different resolutions are fused to obtain the first target convolutional feature, so that the first target convolutional feature can include more comprehensive and abundant feature information.

Then the first target convolutional feature is downsampled and further compressed to obtain a feature representation, and a feature that is more abstract and has more global semantics is extracted to obtain the first image feature of the to-be-detected image.

Specifically, FIG. 9 is a schematic diagram of a process of extracting a first image feature according to another embodiment of this disclosure. As shown in FIG. 9, after initial convolutional features outputted by all convolutional branches (including a convolutional branch L1, a convolutional branch L2, a convolutional branch L3, and a convolutional branch L4) in the last stage are obtained, convolution is performed, based on resolutions of the convolutional branches, on the initial convolutional features outputted by the convolutional branches, so that each convolutional branch can obtain a second target convolutional feature with a resolution the same as that of the convolutional branch.

Then all second target convolutional features may be concatenated to form the first target convolutional feature. In this case, a quantity of channels of the first target convolutional feature is much greater than a quantity of channels of the to-be-detected image.

Then the first target convolutional feature is downsampled, the target convolutional feature is compressed, and dimensionality of the first target convolutional feature is reduced, so that a resolution of the first image feature is equal to a minimum resolution of output features in all the convolutional branches.

In a possible implementation, in a process of sequentially performing convolution on the to-be-detected image in the plurality of stages, when a minimum resolution in a current stage meets a preset resolution threshold, adding a new convolutional branch is stopped, and the current stage is used as a last stage of the convolution process, to be specific, each convolutional branch performs convolution for the last time.

Each time a new convolutional branch is introduced, more convolution operations are added. This is likely to reduce training efficiency due to excessively high complexity of the model. In addition, an excessively low resolution may cause loss of a large amount of useful detail information, affecting quality of the first image feature obtained through subsequent feature fusion. Therefore, whether the minimum resolution in the current stage meets the preset resolution threshold is determined, to determine whether the current stage is to be the last stage of the convolution process.

When the current stage is the last stage, an output (that is, an initial convolutional feature) of a current convolutional branch in the last stage is correspondingly upsampled or downsampled based on a resolution magnitude relationship between the current convolutional branch and a remaining convolutional branch, to obtain a convolutional feature whose resolution corresponds to a resolution of the remaining convolutional branch, and obtain a second target convolutional feature of each convolutional branch.

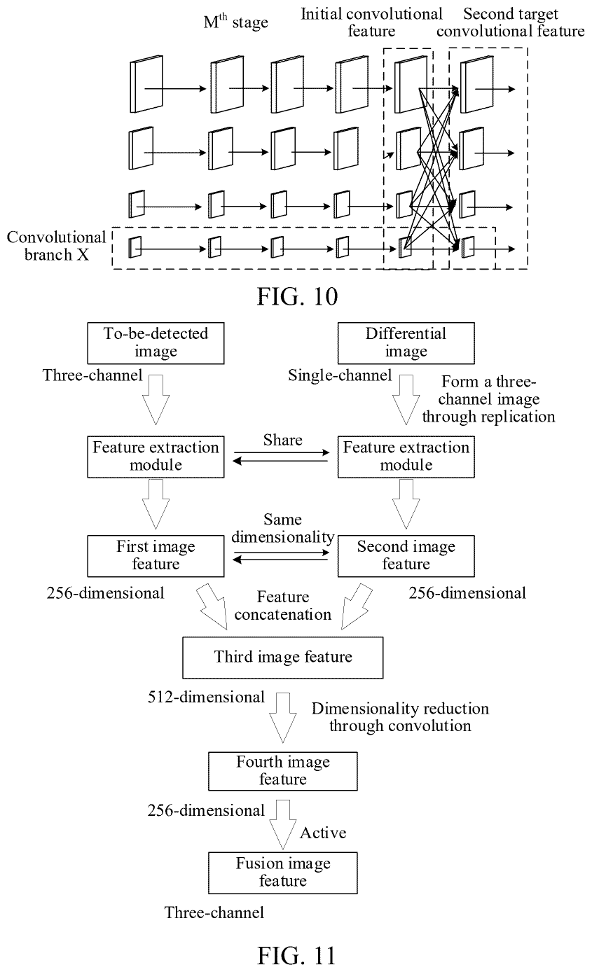

FIG. 10 is a schematic diagram of extracting a second target convolutional feature according to an embodiment of this disclosure. As shown in FIG. 10, when a resolution corresponding to a new convolutional branch (a convolutional branch X) introduced into an M^{th} stage meets a preset resolution threshold, it can be determined that the M^{th} stage is a last stage of feature extraction. Therefore, initial convolutional features outputted by all convolutional branches in the M^{th} stage (the last stage) may be obtained, a plurality of initial convolutional features are fused, and then convolution with a resolution the same as that of each convolutional branch is performed on a fusion convolutional feature to obtain a second target convolutional feature with a corresponding resolution.

Specifically, in a process of fusing the plurality of initial convolutional features, each initial convolutional feature may be upsampled or downsampled based on a resolution magnitude relationship between the convolutional branch and a remaining convolutional branch, and added to a to-be-fusion feature set of a convolutional branch with a corresponding resolution in the M^{th} stage. Then convolution with a corresponding resolution is performed on all initial convolutional features in the to-be-fusion feature set, to generate a second target convolutional feature with a resolution the same as that of each convolutional branch.

In a possible implementation, in a process of fusing the first image feature and the second image feature to obtain the target image feature, a feature value of each pixel in the first image feature may be concatenated with a feature value of a corresponding pixel in the second image feature to obtain a third image feature; then dimensionality of the third image feature is reduced to obtain a fourth image feature; and then the fourth image feature is activated to obtain the target image feature.

FIG. 11 is a schematic diagram of a process of generating a target image feature according to an embodiment of this disclosure. The differential image is a grayscale image, namely, a single-channel image, and the to-be-detected image is an RGB color image, namely, a three-channel image. To reuse a feature extraction module to accelerate convergence of training, single-channel data of the differential image may be first replicated to form an image with three-channel data, so that a quantity of channels of the differential image is equal to a quantity of channels of the to-be-detected image. Then the differential image with the three-channel data and the to-be-detected image are separately input to a same feature extraction module in the defect detection model, to obtain the first image feature and the second image feature respectively. Dimensionality of the first image feature is the same as dimensionality of the second image feature, and both are 256.

The first image feature and the second image feature are concatenated to obtain the third image feature. The concatenation operation is equivalent to splicing two feature tensors along a channel dimension (or a feature dimension), to fuse and retain information included in the first image feature and the second image feature.

Dimensionality corresponding to the third image feature obtained through fusion is 256×2, and the third image feature has redundant information. Therefore, channel dimensionality reduction may be performed on the third image feature by using a 1×1 convolution kernel, to obtain the fourth image feature with dimensionality of 256, to reduce unnecessary feature dimensions, compress a feature representation, and reduce calculation overheads of subsequent processing. In addition, by mapping a high-dimensional feature to a low-dimensional space, a higher-level feature representation can be effectively extracted from the third image feature. This helps extract more global and abstract information, to improve quality and reliability of the fourth image feature.

Then the fourth image feature is activated by using an activation function, to obtain the target image feature. To be specific, a quantity of channels of the fourth image feature and a quantity of channels of the target image feature are the same as a quantity of channels of the to-be-detected image.

In a possible implementation, the defect detection model includes a plurality of cascaded stages based on N network heads, a local region feature extractor connected to each network head, and a region proposal network (RPN), N being a positive integer greater than one. In a process of performing defect detection on the to-be-detected image based on the target image feature to obtain the defect detection bounding box information in the to-be-detected image, the target image feature may be first inputted to the RPN for region extraction, to obtain reference detection bounding box coordinates.

For the first network head, the reference detection bounding box coordinates and the target image feature are inputted to a first local region feature extractor connected to the first network head for pooling, an obtained pooling feature is inputted to the first network head for defect detection, and a first set of defect detection bounding box coordinates are outputted.

For each of n-th network heads of the N network heads (n ranging from two to N), the (n−1)-th set of defect detection bounding box coordinates outputted by a previous network head and the target image feature are inputted to an n-th local region feature extractor connected to the n-th network head for pooling, an obtained pooling feature is inputted to the n-th network head for defect detection, and an n-th set of defect detection bounding box coordinates are outputted.

The N-th defect detection bounding box coordinates outputted by the N-th network head are determined as the defect detection bounding box information.

Specifically, during pooling, a region of interest (ROI) pooling technology may be used to extract a feature region with a specific size. Convolutional feature maps corresponding to ROIs with different sizes are extracted from the target image feature based on a feature mapping relationship, and are pooled to form feature maps with same dimensionality.

The RPN is a fully convolutional network that uses an image with any size as an input to output a group of rectangular target proposals. Each proposal has a target score. Therefore, a boundary of the defect detection bounding box and a confidence level of the defect detection bounding box may be predicted for the target image feature through the RPN.

Specifically, the target image feature is inputted to the RPN, to extract a possible defect region in the target image feature, and output coordinates of a reference detection bounding box.

After initial reference detection bounding box coordinates are obtained through the RPN, a network head in a subsequent stage may obtain more detailed and accurate defect detection bounding box coordinates through optimization by using the initial reference detection bounding box coordinates.

All non-first network heads can receive an output of a previous network head. A multi-concatenation mode enables the network heads to continuously learn and extract higher-level feature representations, to further optimize and refine the defect detection bounding box, and improve accuracy of the defect detection bounding box.

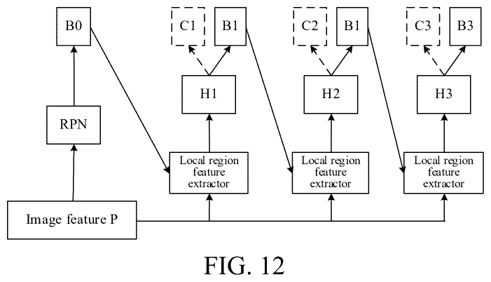

FIG. 12 is a schematic diagram of a defect detection process according to an embodiment of this disclosure. The defect detection model may be referred to as a cascaded region-based convolutional neural network (R-CNN) and includes a plurality of network heads. As shown in FIG. 12, the defect detection model may include a network head H1, a network head H2, a network head H3, and a local region feature extractors. The network head H1 is the first network head, and the network head H3 is the last network head.

First, the target image feature (namely, an image feature P) is inputted to the RPN for region extraction, to obtain reference detection bounding box coordinates B0.

Then the reference detection bounding box coordinates B0 and the image feature P are inputted to a first local region feature extractor for ROI pooling, to extract a pooling feature, and transmit the pooling feature to the first network head H1. The network head H1 can adjust a position and a size of the defect detection bounding box based on the reference detection bounding box coordinates B0, and then output defect detection bounding box coordinates B1. The network head H1 may further classify a defect, and output a classification result C1 of the defect detection bounding box coordinates B1. The classification result C1 is configured for indicating a defect category corresponding to the defect detection bounding box coordinates B1.

Then the defect detection bounding box coordinates B1 and the image feature P are inputted to a second local region feature extractor for ROI pooling, to extract a pooling feature in this stage, and transmit the pooling feature to the next network head H2 for defect detection. The position and the size of the defect detection bounding box are further adjusted, and new defect detection bounding box coordinates B2 are outputted. In addition, the network head H2 may further output a classification result C2 configured for indicating a defect category of the defect detection bounding box coordinates B2.

Then the defect detection bounding box coordinates B2 and the image feature P are inputted to a third local region feature extractor for ROI pooling. After a new pooling feature is extracted, the new pooling feature is inputted to the last network head H3. The network head H3 performs last defect detection based on the pooling feature, adjusts the position and the size of the defect detection bounding box again, outputs new defect detection bounding box coordinates B3, and uses the defect detection bounding box coordinates B3 as the defect detection bounding box information of the to-be-detected image. In addition, the network head H3 may also detect a classification result C3 corresponding to the defect detection bounding box coordinates B3, so that the defect detection bounding box information of the to-be-detected image may further include a classification result of a defect category of a corresponding defect detection bounding box.

A detection result in each stage affects effect of defect detection in a next stage. Therefore, the model can gradually improve a detection result through iteration. To be specific, a reference defect detection bounding box is roughly located through the RPN, and then a position and a size of the defect detection bounding box are continuously refined through a plurality of network heads, to improve detection accuracy.

In a possible implementation, the defect detection bounding box information includes defect detection bounding box coordinates, a detection bounding box confidence probability, and a target defect category. In a process of determining the second detection result of the target workpiece based on the defect detection bounding box information and the first detection result, when the first detection result indicates that the target workpiece has no defect, a preset confidence probability threshold and a preset area threshold that correspond to the target defect category are obtained. Then a defect area is determined based on the defect detection bounding box coordinates, and a first magnitude relationship between the defect area and the preset area threshold, and a second magnitude relationship between the detection bounding box confidence probability and the preset confidence probability threshold are determined. Then the second detection result of the target workpiece is determined based on the first magnitude relationship and the second magnitude relationship.

When the first detection result indicates that the target workpiece has no defect, it is determined, based on the differential image, that the target workpiece has no visually clear defect. Therefore, the defect detection bounding box information outputted by the defect detection model may be filtered by using the preset confidence probability threshold and the preset area threshold, to further determine whether the target workpiece has a defect, and reduce occurrence of false positives and false negatives.

While outputting defect detection bounding box coordinates, the defect detection model further outputs a target defect category (that is, the classification result in FIG. 12) and a detection bounding box confidence probability that correspond to the defect detection bounding box coordinates.

The target workpiece may include a plurality of defect categories, such as stain, discoloration, scratches, damage, and dents. The target workpiece has different quality inspection criteria for different defect categories. Therefore, the preset confidence probability threshold and the preset area threshold, that is, the quality inspection criteria, need to be obtained based on a target defect category corresponding to each defect detection bounding box. A first magnitude relationship between a defect area of the defect detection bounding box and the preset area threshold, and a second magnitude relationship between a detection confidence probability and the preset confidence probability threshold are separately obtained through comparison, to determine whether the defect detection bounding box includes a defect that fails quality inspection.

The first magnitude relationship is configured for indicating whether the defect area exceeds the preset area threshold, and may indicate quality of the target workpiece. If the defect area is greater than or equal to the preset area threshold, it can be considered that the quality of the target workpiece does not meet a criterion, and the target workpiece has a defect.

The second magnitude relationship is configured for indicating a possibility of the defect detection bounding box, and may indicate a possibility that the target workpiece has the defect. If the second magnitude relationship is the detection bounding box confidence probability being greater than the preset confidence probability threshold, it can be considered that the target workpiece has a defect at a position of the corresponding defect detection bounding box.

The second detection result of the target workpiece is determined based on the first magnitude relationship and the second magnitude relationship, and determining logic may be adjusted based on an actual quality inspection status. For example, when the first magnitude relationship is the defect area being greater than or equal to the preset area threshold or the second magnitude relationship is the detection bounding box confidence probability being greater than the preset confidence probability threshold, it can be determined that the second detection result of the target workpiece is that the target workpiece has a defect and fails quality inspection. For another example, when the first magnitude relationship is the defect area being greater than or equal to the preset area threshold and the second magnitude relationship is the detection bounding box confidence probability being greater than the preset confidence probability threshold, it can be determined that the second detection result of the target workpiece is that the target workpiece has a defect.

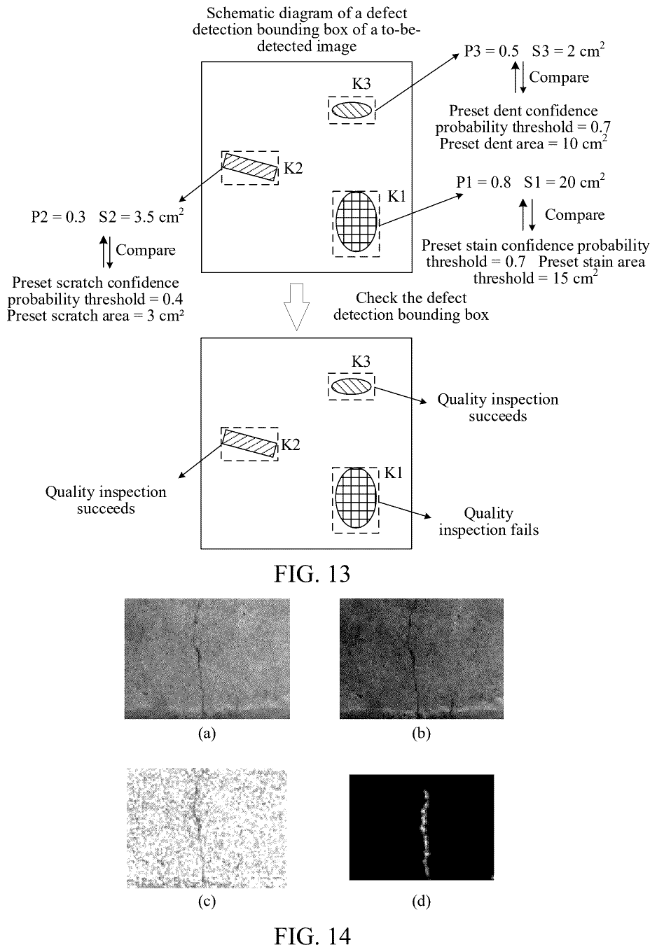

Specifically, FIG. 13 is a schematic diagram of a process of determining a second detection result according to an embodiment of this disclosure. When the first detection result indicates that the target workpiece has no defect, the defect detection bounding box information outputted by the defect detection model is obtained. The defect detection bounding box information specifically includes defect detection bounding box coordinates K1, defect detection bounding box coordinates K2, and defect detection bounding box coordinates K3. A detection bounding box confidence probability P1 corresponding to the defect detection bounding box coordinates K1 is 0.8, and a corresponding target defect category is stain. A detection bounding box confidence probability P2 corresponding to the defect detection bounding box coordinates K2 is 0.3, and a corresponding target defect category is scratches. A detection bounding box confidence probability P3 corresponding to the defect detection bounding box coordinates K3 is 0.5, and a corresponding target defect category is dents.

Then preset confidence probability thresholds and preset area thresholds that respectively correspond to the defect categories of stain, scratches, and dents are obtained. Specifically, a preset stain confidence probability threshold corresponding to stain is 0.7, and a preset stain area threshold is 15 cm²; a preset scratch confidence probability threshold corresponding to scratches is 0.4, and a preset scratch area is 3 cm²; and a preset dent confidence probability threshold corresponding to dents is 0.7, and a preset dent area is 10 cm².

Then a corresponding defect area is determined based on the defect detection bounding box coordinates. Specifically, a stain defect area S1 obtained through calculation by using the defect detection bounding box coordinates K1 is 20 cm², a scratch defect area S2 obtained through calculation by using the defect detection bounding box coordinates K2 is 3.5 cm², and a dent defect area S3 obtained through calculation by using the defect detection bounding box coordinates K3 is 2 cm².

By comparing a defect area of each defect category with the preset area threshold and comparing a detection bounding box confidence probability with the preset confidence probability threshold, it can be found that a first magnitude relationship of the stain category is the stain defect area being greater than the preset stain area threshold, and a second magnitude relationship of the stain category is a stain detection bounding box confidence probability being greater than the preset stain confidence probability. Therefore, it is considered that a defect marked by the defect detection bounding box coordinates K1 is a defect failing quality inspection. A first magnitude relationship of the dent category is the dent defect area being less than the preset dent area threshold, and a second magnitude relationship of the scratch category is a scratch detection bounding box confidence probability being less than the preset scratch confidence probability. Therefore, it can be considered that defects marked by the defect detection bounding box coordinates K2 and the defect detection bounding box coordinates K3 are defects that can succeed in quality inspection. However, the target workpiece has a defect that fails quality inspection, that is, the defect marked by the defect detection bounding box coordinates K1. Therefore, it can be determined that the second detection result of the target workpiece is that the target workpiece has a defect and fails quality inspection.

In a possible implementation, when the first detection result indicates that the target workpiece has a defect, it is determined that the second detection result of the target workpiece is that the target workpiece has a defect. If the first detection result indicates that the target workpiece has a defect, the target workpiece has a visually clear defect. No further determining needs to be performed, and it can be directly determined that the second detection result of the target workpiece is that the target workpiece has a defect, to improve efficiency of defect detection.

Defect detection may be performed on the target workpiece separately based on a comparison method and a model-based prediction method.

A first detection result is first obtained for the target workpiece based on the comparison method. If the first detection result is that the target workpiece has a defect, it can be directly determined that a second detection result indicating that the target workpiece has a defect is that the target workpiece has a defect, and defect detection bounding box information obtained by using the model-based prediction method does not need to be considered.

If a reference defect result is that the target workpiece has no defect, defect detection bounding box information outputted by the defect detection model needs to be obtained, and then comparison is performed, based on defect detection bounding box coordinates and a detection bounding box confidence probability in the defect detection bounding box information and a target defect category, with a preset confidence probability threshold and a preset area threshold that correspond to the target defect category, to determine a target reference defect result.

In a possible implementation, in a process of comparing the to-be-detected image with the template image to obtain the differential image, a transformation parameter between the to-be-detected image and the template image may be first determined; a target workpiece displayed in the template image is aligned with a target workpiece displayed in the to-be-detected image based on the transformation parameter, to obtain an aligned to-be-detected image; the aligned to-be-detected image is compared with the template image to obtain an initial differential image; and the initial differential image is filtered to obtain the differential image.

The to-be-detected image of the target workpiece is usually captured by a camera device, a photographing position or a placement direction of each target workpiece is likely to deviate, and the to-be-detected image and the template image are obtained under different conditions, for example, at different time or different viewing angles. Consequently, the target workpiece displayed in the obtained to-be-detected image can be hardly aligned with the target workpiece displayed in the template image, affecting comparison effect.

Therefore, the to-be-detected image may be aligned with the template image, so that the target workpiece displayed in the to-be-detected image is aligned with the target workpiece displayed in the template image, to improve comparison effect, and improve accuracy of an initial differential image.

Specifically, the transformation parameter between the to-be-detected image and the template image is first determined, and the to-be-detected image and the template image are aligned to same coordinate space, so that pixels at a same coordinate position correspond to a same actual position, to ensure that comparison is performed between content in a same region during comparison.

The transformation parameter is determined, and image alignment is performed, so that the to-be-detected image and the template image are consistent in space. This helps effectively extract information in the two images, and eliminate noise resulting from a view difference, to help obtain a more accurate initial differential image.

FIG. 14 is a schematic diagram of effect of morphological filtering according to an embodiment of this disclosure. Even if image alignment is performed between the to-be-detected image and the template image, edge regions of the two images inevitably include parts that cannot be aligned, likely leading to noise and interfering with generation of a differential image. Therefore, morphological image processing and filtering (such as expansion, corrosion, filtering, and smoothing) may be performed on the initial differential image to eliminate edge noise.

As shown in section (a) in FIG. 14, a corrosion operation may be performed on the initial differential image, to erode or narrow an edge in the initial differential image, to obtain an eroded effect image shown in section (b) in FIG. 14. To be specific, each pixel f(x, y) in the initial differential image f is replaced with a minimum value in a set B (adjacent pixels), and a corrosion operation is performed on the initial differential image f by using the set B. A specific formula is shown as follows:

f⊖B=min[f(x+s,y+t)](s,t)∈B (2)

In another embodiment, an edge in the initial differential image may be expanded to obtain an expanded effect image shown in section (c) in FIG. 16. To be specific, each pixel f(x, y) in the initial differential image f is replaced with a maximum value in a set C (adjacent pixels), and an expansion operation is performed on the initial differential image f by using the set C. A specific formula is shown as follows:

f⊕C=max[f(x+w,y+v)](w,v)∈C (3)

After the morphological filtering, noise at an edge of the initial differential image may be removed to obtain a differential image. The differential image and the to-be-detected image are inputted to the defect detection model, to assist the model in performing feature extraction and defect detection, so that the model can accurately locate a defect region image shown in section (d) in FIG. 14. The defect region image is partial image information in the defect detection bounding box information outputted by the model.

In a possible implementation, in a process of determining the transformation parameter between the to-be-detected image and the template image, a current window region may be determined in the to-be-detected image by using a sliding window; a correlation coefficient between an image in the current window region and an image in a corresponding window region in the template image is calculated; a target region in the to-be-detected image is determined based on a correlation coefficient of each window region; a transformation matrix needed for transforming the target region into an aligned region in the template image is determined; and an inverse matrix of the transformation matrix is determined as the transformation parameter.

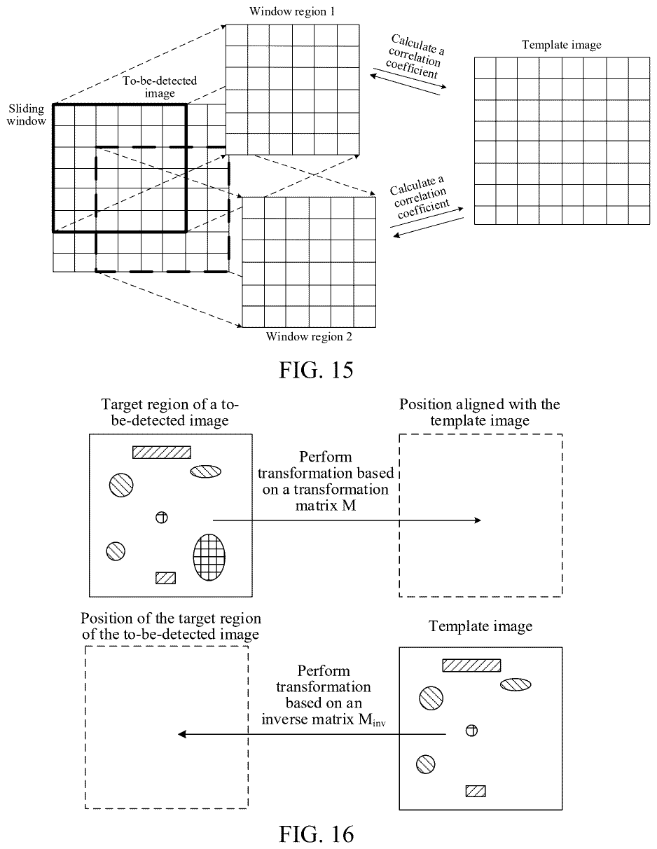

FIG. 15 is a schematic diagram of a process of determining a correlation coefficient according to an embodiment of this disclosure. In a sliding window method, the to-be-detected image is slid based on a size of a window, and a correlation coefficient between corresponding window regions in the template image and the to-be-detected image is calculated each time, so that a similarity between the two images can be measured. In this way, a region most similar to the template image, that is, a window region with a largest correlation coefficient, can be found in the to-be-detected image as the target region.

After the target region is obtained, the transformation matrix may be determined. The transformation matrix describes geometrical transformation, such as displacement, rotation, or distortion, needed for converting the target region in the to-be-detected image into a region aligned with the template image. The transformation matrix M may be as follows:

$$( \begin{matrix}s cos θ & - s sin θ & x \\ s sin θ & - s cos θ & {t}_{y} \\ 0 & 0 & 1\end{matrix} )$$

(tₓ, t_{y}) in the transformation matrix M represents a displacement vector. A rotation angle θ is added based on the displacement vector. A zooming transformation parameter s is added based on the displacement and the rotation to implement similarity transformation. The similarity transformation makes a distance between points change before and after the transformation, but keeps an angle unchanged.

FIG. 16 is a schematic diagram of a similarity transformation correspondence between a template image and a to-be-detected image according to an embodiment of this disclosure. After the transformation matrix M is determined, the inverse matrix Mᵢₙᵥ of the transformation matrix M further needs to be calculated. The inverse matrix Mᵢₙᵥ can be used for transformation from the template image to the target region in the to-be-detected image, to be specific, transforming the target workpiece displayed in the template image to a position of a target workpiece displayed in the target region in the to-be-detected image, to align the workpieces.

A correlation coefficient between corresponding regions in the template image and the to-be-detected image may be calculated based on a correlation between a relative value of a pixel value of a pixel in the template image with respect to an average pixel value of the template image, and a relative value of a pixel value of a pixel in a corresponding region in the to-be-detected image with respect to an average pixel value of the corresponding region. A larger correlation coefficient indicates higher matching between corresponding regions in the to-be-detected image and the template image. A calculation formula for the correlation coefficient is as follows:

$$R ( x , y ) = \frac{{\sum }_{{x}^{′} , y} , [ {T}^{′} ( {x}^{′} , {y}^{′} ) {I}^{′} ( x + {x}^{′} , y + {y}^{′} ) ]}{\sqrt{{\sum }_{{x}^{′} , y} , {{T}^{′} ( {x}^{′} , {y}^{′} )}^{2} {\sum }_{{x}^{′} , y} , {{I}^{′} ( x + {x}^{′} , y + {y}^{′} )}^{2}}} \qquad ( 4 )$$

T′(x′, y′) represents a relative value of a pixel value at coordinates (x′, y′) in the template image with respect to an average pixel value of the template image. I′(x+x′, y+y′) represents a relative value of a pixel value at coordinates (x+x′, y+y′) in a corresponding window region in the to-be-detected image with respect to an average pixel value of the window region.

In a possible implementation, grayscale conversion may be separately performed on the template image and the to-be-detected image, and then a difference, a mean absolute difference, a sum of absolute differences, a mean squared error, a normalized product, or the like is calculated as the correlation coefficient based on a grayscale value of a sliding window region in the to-be-detected image and a grayscale value of the template image, to determine the target region.

In a possible implementation, image matching may be performed between the sliding window region in the to-be-detected image and the template image by using a deep learning-based registration algorithm, for example, a graph convolutional neural network-based feature matching algorithm (SuperGlue) or a deep learning-based self-supervised feature point detection algorithm (SuperPoint).

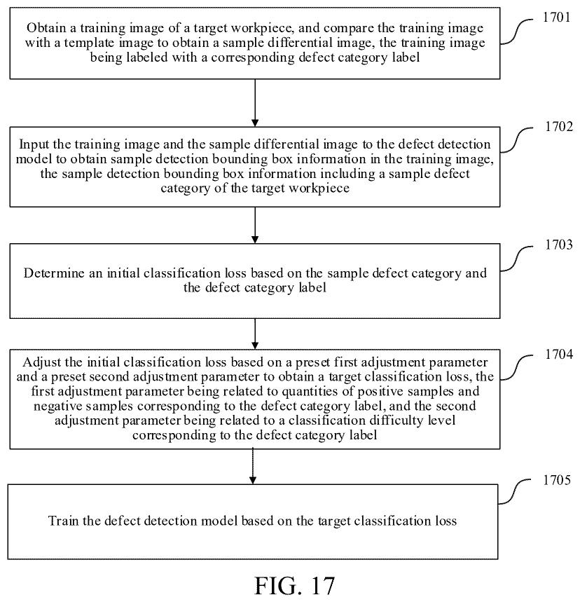

In a possible implementation, FIG. 17 is a schematic diagram of a training process for a defect detection model according to an embodiment of this disclosure. The defect detection model may be obtained through training through the following operation 1701 to operation 1705.

Operation 1701: Obtain a training image of a target workpiece, and compare the training image with a template image to obtain a sample differential image, the training image being labeled with a corresponding defect category label.

Operation 1702: Input the training image and the sample differential image to the defect detection model to obtain sample detection bounding box information in the training image, the sample detection bounding box information including a sample defect category of the target workpiece.

Operation 1703: Determine an initial classification loss based on the sample defect category and the defect category label.

Operation 1704: Adjust the initial classification loss based on a preset first adjustment parameter and a preset second adjustment parameter to obtain a target classification loss, the first adjustment parameter being related to quantities of positive samples and negative samples corresponding to the defect category label, and the second adjustment parameter being related to a classification difficulty level corresponding to the defect category label.

Operation 1705: Train the defect detection model based on the target classification loss.

Specifically, a defect feature of the target workpiece can be better learned by comparing the training image with the template image, and the sample differential image helps highlight a difference between a defect region and a normal region. Then the training image and the sample differential image are inputted to the defect detection model. The sample differential image provides difference information for the model, to assist the model in learning and training, and improve a generalization capability of the model.

The initial classification loss may be determined based on a cross-entropy loss function by using the sample defect category and the defect category label.

Then the first adjustment parameter and the second adjustment parameter are preset, and the initial classification loss may be adjusted by using the first adjustment parameter and the second adjustment parameter, to obtain a target loss function. Specifically, the target loss function may be expressed as the following formula:

$$Loss ( x , class ) = - {{α}_{class} ( 1 - \frac{{e}^{x [ class ]} ]}{{\sum }_{j} {e}^{x [ j ]}} )}^{γ} log ( \frac{{e}^{x [ class ]}}{{\sum }_{j} {e}^{x [ j ]}} ) \qquad ( 5 )$$

x represents a prediction store vector outputted by the defect detection model. class represents the defect category label. x[class] represents an original prediction score of the defect detection model with respect to that a currently outputted defect belongs to a specific category. α_{class} represents the first adjustment parameter. γ represents the second adjustment parameter.

$$\frac{{e}^{x [ c l a s s ]}}{{\sum }_{j} {e}^{x [ j ]}}$$

represents a cross-entropy operation process. An original output of the model is converted into a probability form, to obtain a prediction probability that the currently outputted defect belongs to the specific category. A higher prediction probability indicates that the currently outputted defect is closer to the specific type and classification is more accurate.

In comparison with the cross-entropy loss function, a modulation factor

$${( 1 - \frac{{e}^{x [ c l a s s ]}}{{\sum }_{j} {e}^{x [ j ]}} )}^{γ}$$

is added to the target loss function. For an accurately classified sample, a prediction probability approaches 1, and the modulation factor approaches 0. For an inaccurately classified sample, the modulation factor approaches 0. Therefore, in comparison with the cross-entropy loss function, in the target loss function, for an inaccurately classified sample, a loss does not change; and for an accurately classified sample, a loss decreases. Therefore, from an overall perspective, this is equivalent to increasing a weight of an inaccurately classified sample in the target loss function. In addition, the outputted prediction probability can indicate a classification difficulty level of the model. A higher prediction probability indicates a higher classification confidence level of the model and indicates that it is easier to classify a sample. A lower prediction probability indicates a lower classification confidence level of the model and indicates that it is more difficult to classify a sample.

Therefore, the target loss function can increase a weight of a sample with low distinguishability in the target loss function, so that the target loss function focuses more on the sample with low distinguishability. This helps improve accuracy of classifying a difficult sample.

It is easy to obtain a training image of a target workpiece without a defect, but it is difficult to obtain a target workpiece with a defect. In addition, with an increase in a quantity of defect categories, a larger quantity of defect samples are needed. Therefore, an imbalance between a quantity of positive samples and a quantity of negative samples may be suppressed by using the first adjustment parameter, and an imbalance between a quantity of simple samples and a quantity of samples with low distinguishability may be controlled by using the second adjustment parameter. A positive sample may be expressed as a sample image of a target workpiece with a defect, and a negative sample may be expressed as a sample image of a target workpiece without a defect.

It can be learned from the foregoing formula (5) that a loss ratio between positive samples and negative samples is adjusted by using the first adjustment parameter, and a loss ratio between difficult samples and simple samples is adjusted by using the second adjustment parameter, to address an imbalance between categories during object detection, and reduce a weight of a sample that can be easily classified, so that the model focuses more on a difficult sample during training.

In a possible implementation, the second adjustment parameter may include a first decoupling factor and a second decoupling factor. The first decoupling factor is expressed as a base value for adjusting a loss ratio between samples corresponding to different classification difficulty levels. The second decoupling factor is expressed as a variable parameter related to an imbalance between samples of each category.

Specifically, refer to the second adjustment parameter γ in the formula (5).

$$γ = {γ}_{b} + {γ}_{v}^{j} = {γ}_{b} + s ( 1 - {g}^{j} ) ,$$

where γ_{b} represents the first decoupling factor,

$${γ}_{v}^{j}$$

represents the second decoupling factor, j represents a sample of a j^{th} category, and g^{j} represents a training balance coefficient of the sample of the j^{th} category. A larger value of g^{j} indicates that training of the sample of the j^{th} category is more balanced. A smaller value of g^{j} indicates that training of the sample of the category is more unbalanced. s represents a scaling factor, in the target loss function, that determines an upper limit of the second adjustment parameter, to be specific, is configured for assisting in adjusting an imbalance between a quantity of simple samples and a quantity of samples with low distinguishability.

Therefore, the second adjustment parameter is decoupled to form the first decoupling factor and the second decoupling factor, so that an imbalance between samples of each category can be independently processed by using the first decoupling factor and the second decoupling factor, to improve performance of the model. Specifically, for example, a total quantity of sample categories is C. The target loss function based on the first adjustment parameter, the first decoupling factor, and the second decoupling factor may be expressed as the following formula:

$$Loss = ( x , class ) = - {\sum }_{j}^{C} {α}_{class} ( \frac{{γ}_{b} + {γ}_{v}^{j}}{{γ}_{b}} ) {( 1 - \frac{{e}^{x [ class ] ]}}{{\sum }_{j} {e}^{x [ j ]}} )}^{{γ}_{b} + {γ}_{v}^{j}} log ( \frac{{e}^{x [ class ]}}{{\sum }_{j} {e}^{x [ j ]}} ) \qquad ( 6 )$$

In a possible implementation, during training of the defect detection model, the sample detection bounding box information includes a defect detection bounding box and a corresponding detection bounding box confidence level. After the sample detection bounding box information is obtained, non-maximum suppression may be performed based on the detection bounding box confidence level. Sorting is performed based on detection bounding box confidence levels corresponding to defect detection bounding boxes. A defect detection bounding box of a difficult sample (with a low detection bounding box confidence level) is inputted to training in a next stage for forward propagation and back propagation, so that the model can obtain more targeted information during supervised training, to improve a speed and quality of training.

Specifically, an intersection over union (IoU) of each defect detection bounding box is calculated. The IoU is a ratio of an intersection set between each defect detection bounding box and a defect detection bounding box currently having a highest detection bounding box confidence level to a union set thereof. A detection bounding box confidence level corresponding to each defect detection bounding box is adjusted based on the IoU of each defect detection bounding box. When the IoU exceeds a preset ratio threshold, the detection bounding box confidence level corresponding to the defect detection bounding box is reduced. If the IoU does not exceed the preset ratio threshold, the detection bounding box confidence level corresponding to the defect detection bounding box is not adjusted. Specifically, an adjustment formula for a detection bounding box confidence level is as follows:

$${s}_{i} = \{ \begin{matrix}{s}_{i} , IoU ( M , {b}_{i} ) < {N}_{t} \\ {s}_{i} ( 1 − IoU ( M , {b}_{i} ) ) , IoU ( M , {b}_{i} ) \geq {N}_{t}\end{matrix} \qquad ( 7 )$$

Nₜ represents the preset ratio threshold. IoU(M, bᵢ) represents an IoU of a defect detection bounding box. M represents a defect detection bounding box with a highest detection bounding box confidence level. bᵢ represents a current defect detection bounding box. sᵢ represents a detection bounding box confidence level of the current defect detection bounding box bᵢ. Therefore, overlapping and unclear defects can be retained, to reduce probabilities of missing detection and false detection.

In a possible implementation, in a process of training the defect detection model based on the target classification loss, a coordinate difference of a defect detection bounding box may be further determined based on coordinates of the defect detection bounding box in the sample detection bounding box information and coordinates of an actual label detection bounding box marked in the training image. Then a regression loss of the defect detection bounding box is determined based on the coordinate difference. Then the defect detection model is trained based on the regression loss and the target classification loss.

Therefore, the defect detection model is trained based on to the regression loss and the target classification loss, fitted regression is performed on the coordinates of the defect detection bounding box by using the regression loss, and a category of the defect detection bounding box is supervised and constrained by using the target classification loss, to provide guidance for the defect detection model in regression and classification of the defect detection bounding box, improve performance of the defect detection model, and alleviate impact of an imbalance between sample categories in the defect detection model.

In a possible implementation, the sample detection bounding box information in the training image further includes the coordinates of the defect detection bounding box. Therefore, a difference between a defect detection bounding box predicted by the model and the actual label detection bounding box of the training image at coordinates (x, y, w, h) may be calculated. The x element represents a horizontal coordinate of a center of the detection bounding box. The y element represents a vertical coordinate of the center of the detection bounding box. The w element represents a width of the detection bounding box, to be specific, a size along a horizontal direction of the image. The h element represents a height of the detection bounding box, to be specific, a size along a vertical direction of the image.

Specifically, the defect detection bounding box and the actual label detection bounding box may be separately normalized, to eliminate impact of the sizes, and obtain a more accurate coordinate difference. Then the regression loss of the defect detection bounding box may be calculated based on the coordinate difference of the defect detection bounding box by using a regression loss function, for example, a smooth L1 loss function, and then fitted regression may be performed on the detection bounding box by using the regression loss.

Specifically, the regression loss may be optimized by using a gradient descent method. During optimization, parameters of the model are continuously updated, so that a defect detection bounding box predicted and outputted by the model gradually approaches the actual label detection bounding box. By minimizing the regression loss, the defect detection model can obtain a more accurate defect detection bounding box through fitting.

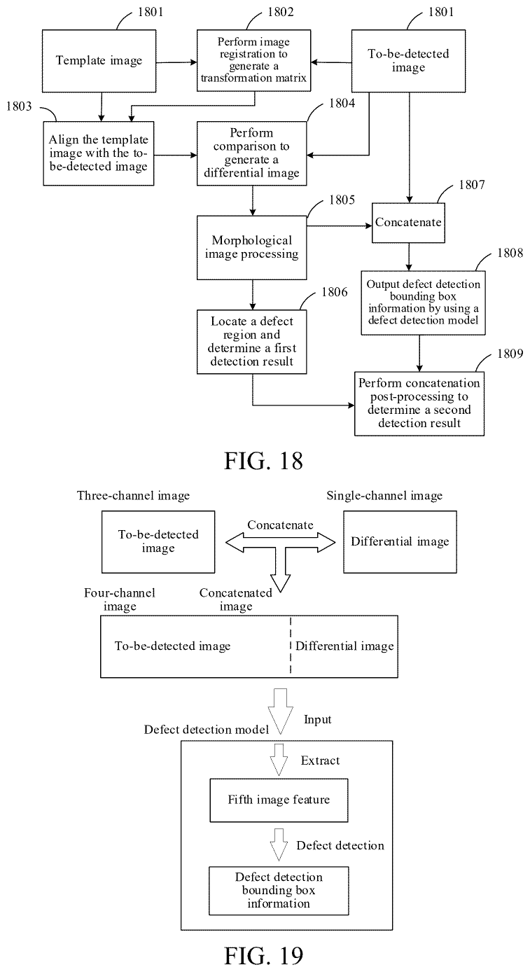

In a possible implementation, FIG. 18 is a schematic diagram of a defect detection process according to another embodiment of this disclosure. As shown in FIG. 18, a defect detection process for a target workpiece may include two branch processes, and one of the branch processes may include the following operations:

1801: Obtain a template image and a to-be-detected image of the target workpiece.

1802: Perform image alignment between the to-be-detected image and the template image to generate a transformation matrix.

1803: Rotate and translate the template image to align the template image with the to-be-detected image.

1804: Compare the to-be-detected image with the template image to generate a differential image.

1805: Perform morphological image processing, such as expansion and corrosion, on the differential image, and filter a noise region (a differential outlier resulting from a slight offset of the workpiece).

1806: Locate a defect region in the differential image based on a logic algorithm, and determine a first detection result.

The other branch process may include the following operations:

1807: Concatenate an image feature of the differential image with an image feature of the to-be-detected image to form four-channel image feature data.

1808: Perform defect detection by using a defect detection model, and output defect detection bounding box information.

1809: Perform concatenation post-processing based on the first detection result and the defect detection bounding box information, to determine a second detection result of the target workpiece.

In the operation of determining the second detection result of the target workpiece based on the first detection result and the defect detection bounding box information, the first detection result and the defect detection bounding box information may be inputted to a concatenation post-processing model for quality inspection prediction, to output the second detection result of the target workpiece.

In a possible implementation, in a process of inputting the to-be-detected image and the differential image to the defect detection model to extract a target image feature, the to-be-detected image and the differential image may be concatenated to obtain a concatenated image, and then the concatenated image is inputted to the defect detection model to extract the target image feature of the concatenated image.

In a possible implementation, scale transformation is first performed between the to-be-detected image and the differential image, to ensure that corresponding dimensionality of the two images in a concatenation direction is consistent. The concatenation between the to-be-detected image and the differential image may be horizontal concatenation or longitudinal concatenation. To be specific, the two images are spliced together along a horizontal direction of the image, or the two images are spliced together along a vertical direction of the image.

FIG. 19 is a schematic diagram of a process of generating defect detection bounding box information according to another embodiment of this disclosure. The to-be-detected image is a three-channel RGB color image, and the differential image may be a single-channel gray image. The to-be-detected image and the differential image are directly concatenated to form a concatenated image. The concatenated image is a four-channel image.

Feature extraction does not need to be separately performed on the to-be-detected image and the differential image, to reduce a loss caused by feature extraction. The concatenated image can retain original feature information of the two images. This facilitates mining and learning of the model, to extract a more accurate target image feature. In addition, inputting the concatenated image to the defect detection model can provide difference information between different images at a same position, to help improve detection accuracy of the model.

The target image feature is extracted based on the concatenated image, the concatenated image is generated by splicing the to-be-detected image and the differential image, and the differential image carries difference information between the target workpiece and a reference workpiece. Therefore, the target image feature can capture key difference information, so that the target image feature can be used to assist the model in performing defect detection, to improve accuracy of the defect detection bounding box information.

The following describes in detail a defect detection method provided in an embodiment of this disclosure.

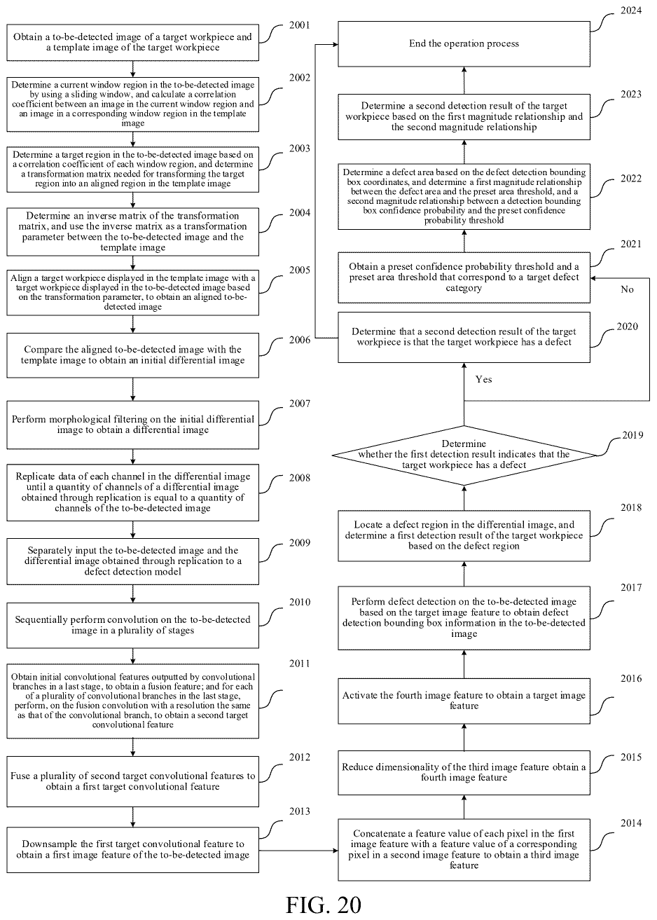

FIG. 20 is a schematic diagram of an overall process of a defect detection method according to an embodiment of this disclosure. The defect detection method includes but is not limited to the following operation 2001 to operation 2024.

Operation 2001: Obtain a to-be-detected image of a target workpiece and a template image of the target workpiece.

Operation 2002: Determine a current window region in the to-be-detected image by using a sliding window, and calculate a correlation coefficient between an image in the current window region and an image in a corresponding window region in the template image.

Operation 2003: Determine a target region in the to-be-detected image based on a correlation coefficient of each window region, and determine a transformation matrix needed for transforming the target region into an aligned region in the template image.

Operation 2004: Determine an inverse matrix of the transformation matrix, and use the inverse matrix as a transformation parameter between the to-be-detected image and the template image.

Operation 2005: Align a target workpiece displayed in the template image with a target workpiece displayed in the to-be-detected image based on the transformation parameter, to obtain an aligned to-be-detected image.

Operation 2006: Compare the aligned to-be-detected image with the template image to obtain an initial differential image.

Operation 2007: Perform morphological filtering on the initial differential image to obtain a differential image.

Operation 2008: Replicate data of each channel in the differential image until a quantity of channels of a differential image obtained through replication is equal to a quantity of channels of the to-be-detected image.

Operation 2009: Separately input the to-be-detected image and the differential image obtained through replication to a defect detection model.

In this operation, the to-be-detected image and the differential image obtained through replication share a same feature extraction module in the defect detection model.

Operation 2010: Sequentially perform convolution on the to-be-detected image in a plurality of stages.

In this operation, each stage includes at least one convolutional branch, and each convolutional branch is configured to perform convolution for a plurality of times. A new convolutional branch is added upon entering a next stage from a current stage, and a resolution of the new convolutional branch is less than that of any existing convolutional branch in the current stage. A feature inputted to any convolutional branch in the current stage being obtained by fusing features outputted by all convolutional branches in a previous stage.

Operation 2011: Obtain initial convolutional features outputted by convolutional branches in a last stage; fuse a plurality of initial convolutional features to obtain a fusion feature; and for each of a plurality of convolutional branches in the last stage, perform, on the fusion feature, convolution with a resolution the same as that of the convolutional branch, to obtain a second target convolutional feature of the convolutional branch.

In this operation, during last convolution, for any second convolutional branch, a feature outputted by the current convolutional branch is upsampled or downsampled based on a resolution magnitude relationship between the current convolutional branch and a remaining second convolutional branch, and added to an input for last convolution of the remaining second convolutional branch. Then an initial convolutional feature outputted by last convolution of each second convolutional branch is obtained.

Operation 2012: Fuse a plurality of second target convolutional features to obtain a first target convolutional feature.

Operation 2013: Downsample the first target convolutional feature to obtain a first image feature of the to-be-detected image.

Operation 2014: Concatenate a feature value of each pixel in the first image feature with a feature value of a corresponding pixel in a second image feature to obtain a third image feature.

Operation 2015: Reduce dimensionality of the third image feature to obtain a fourth image feature.

Operation 2016: Activate the fourth image feature to obtain a target image feature.

Operation 2017: Perform defect detection on the to-be-detected image based on the target image feature to obtain defect detection bounding box information in the to-be-detected image.

In this operation, the defect detection model includes a plurality of network heads, a local region feature extractor connected to each network head, and an RPN. The target image feature is inputted to the RPN for region extraction, to obtain reference detection bounding box coordinates. For the first network head, the reference detection bounding box coordinates and the target image feature are inputted to a local region feature extractor connected to the first network head for pooling, an obtained pooling feature is inputted to the first network head for defect detection, and defect detection bounding box coordinates are outputted. For each of remaining network heads, defect detection bounding box coordinates outputted by a previous network head and the target image feature are inputted to a local region feature extractor connected to the network head for pooling, an obtained pooling feature is inputted to the network head for defect detection, and defect detection bounding box coordinates are outputted. Defect detection bounding box coordinates outputted by a last network head are determined as the defect detection bounding box information.

Operation 2018: Locate a defect region in the differential image, and determine a first detection result of the target workpiece based on the defect region.

Operation 2019: Determine whether the first detection result indicates that the target workpiece has a defect; and if yes, perform operation 2020; or if not, perform operation 2021.

Operation 2020: Determine that a second detection result of the target workpiece is that the target workpiece has a defect, and perform operation 2024.

Operation 2021: Obtain a preset confidence probability threshold and a preset area threshold that correspond to a target defect category.

Operation 2022: Determine a defect area based on the defect detection bounding box coordinates, and determine a first magnitude relationship between the defect area and the preset area threshold, and a second magnitude relationship between a detection bounding box confidence probability and the preset confidence probability threshold.

Operation 2023: Determine a second detection result of the target workpiece based on the first magnitude relationship and the second magnitude relationship.

Operation 2024: End the process.

The following describes in detail a defect detection method provided in another embodiment of this disclosure.

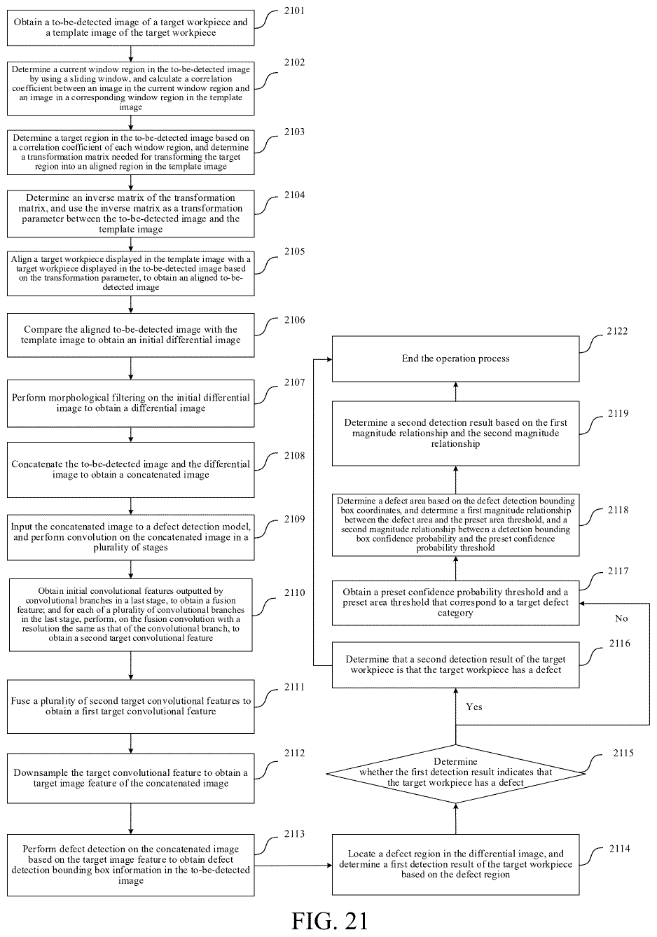

FIG. 21 is a schematic diagram of an overall process of a defect detection method according to an embodiment of this disclosure. The defect detection method includes but is not limited to the following operation 2101 to operation 2120.

Operation 2101: Obtain a to-be-detected image of a target workpiece and a template image of the target workpiece.

Operation 2102: Determine a current window region in the to-be-detected image by using a sliding window, and calculate a correlation coefficient between an image in the current window region and an image in a corresponding window region in the template image.

Operation 2103: Determine a target region in the to-be-detected image based on a correlation coefficient of each window region, and determine a transformation matrix needed for transforming the target region into an aligned region in the template image.

Operation 2104: Determine an inverse matrix of the transformation matrix, and use the inverse matrix as a transformation parameter between the to-be-detected image and the template image.

Operation 2105: Align a target workpiece displayed in the template image with a target workpiece displayed in the to-be-detected image based on the transformation parameter, to obtain an aligned to-be-detected image.

Operation 2106: Compare the aligned to-be-detected image with the template image to obtain an initial differential image.

Operation 2107: Perform morphological filtering on the initial differential image to obtain a differential image.

Operation 2108: Concatenate the to-be-detected image and the differential image to obtain a concatenated image.

Operation 2109: Input the concatenated image to a defect detection model, and perform convolution on the concatenated image in a plurality of stages.

In this operation, each stage includes at least one convolutional branch, and each convolutional branch is configured to perform convolution for a plurality of times. A new convolutional branch is added upon entering a next stage from a current stage, and a resolution of the new convolutional branch is less than that of any existing convolutional branch in the current stage. A feature inputted to any convolutional branch in the current stage being obtained by fusing features outputted by all convolutional branches in a previous stage.

Operation 2110: Obtain initial convolutional features outputted by convolutional branches in a last stage; fuse a plurality of initial convolutional features to obtain a fusion feature; and for each of a plurality of convolutional branches in the last stage, perform, on the fusion feature, convolution with a resolution the same as that of the convolutional branch, to obtain a second target convolutional feature of the convolutional branch.

In this operation, during last convolution, for any second convolutional branch, a feature outputted by the current convolutional branch is upsampled or downsampled based on a resolution magnitude relationship between the current convolutional branch and a remaining second convolutional branch, and added to an input for last convolution of the remaining second convolutional branch. Then an initial convolutional feature outputted by last convolution of each second convolutional branch is obtained.

Operation 2111: Fuse a plurality of second target convolutional features to obtain a first target convolutional feature.

Operation 2112: Downsample the first target convolutional feature to obtain a target image feature of the concatenated image.

Operation 2113: Perform defect detection on the concatenated image based on the target image feature to obtain defect detection bounding box information in the to-be-detected image.

In this operation, the defect detection model includes a plurality of network heads, a local region feature extractor connected to each network head, and an RPN. The target image feature is inputted to the RPN for region extraction, to obtain reference detection bounding box coordinates. For the first network head, the reference detection bounding box coordinates and the target image feature are inputted to a local region feature extractor connected to the first network head for pooling, an obtained pooling feature is inputted to the first network head for defect detection, and defect detection bounding box coordinates are outputted. For each of remaining network heads, defect detection bounding box coordinates outputted by a previous network head and the target image feature are inputted to a local region feature extractor connected to the network head for pooling, an obtained pooling feature is inputted to the network head for defect detection, and defect detection bounding box coordinates are outputted. Defect detection bounding box coordinates outputted by a last network head are determined as the defect detection bounding box information.

Operation 2114: Locate a defect region in the differential image, and determine a first detection result of the target workpiece based on the defect region.

Operation 2115: Determine whether the first detection result indicates that the target workpiece has a defect; and if yes, perform operation 2116; or if not, perform operation 2117.

Operation 2116: Determine that a second detection result of the target workpiece is that the target workpiece has a defect, and perform operation 2120.

Operation 2117: Obtain a preset confidence probability threshold and a preset area threshold that correspond to a target defect category.

Operation 2118: Determine a defect area based on the defect detection bounding box coordinates, and determine a first magnitude relationship between the defect area and the preset area threshold, and a second magnitude relationship between a detection bounding box confidence probability and the preset confidence probability threshold.

Operation 2119: Determine a second detection result of the target workpiece based on the first magnitude relationship and the second magnitude relationship.

Operation 2120: End the process.

Although the operations are shown sequentially according to the instructions of the arrows in the foregoing flowcharts, the operations are not necessarily performed sequentially according to the sequence instructed by the arrows. Unless otherwise explicitly specified in the embodiments, execution of the operations is not strictly limited, and the operations may be performed in other orders. In addition, at least some operations in the foregoing flowcharts may include a plurality of operations or a plurality of stages, and these operations or stages are not necessarily performed at same time, but may be performed at different time. The operations or stages are not necessarily performed sequentially, but may be performed by turn or alternately with other operations or at least a part of operations or stages in other operations.

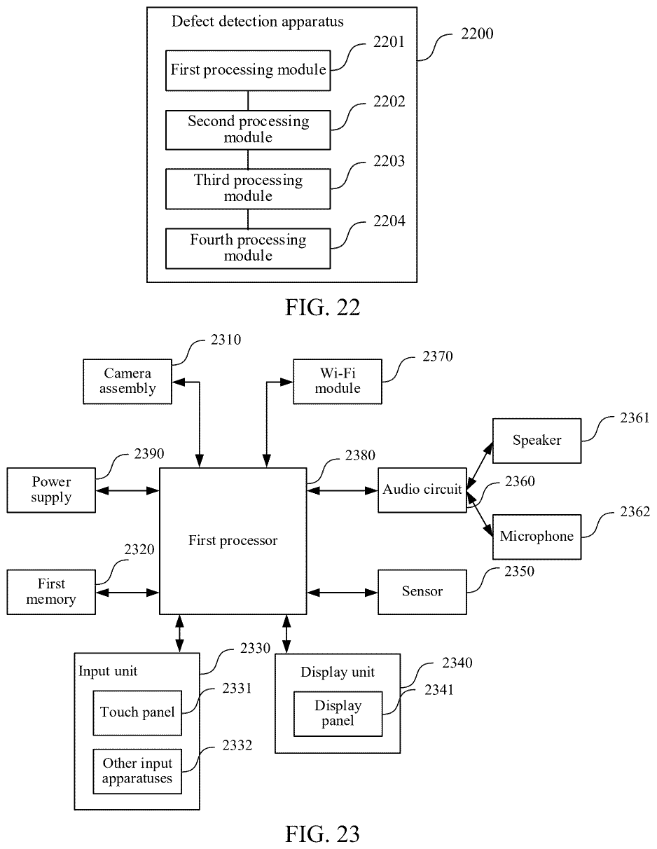

FIG. 22 is a schematic structural diagram of a defect detection apparatus 2200 according to an embodiment of this disclosure. The defect detection apparatus 2200 includes:
a first processing module 2201, configured to obtain a to-be-detected image of a target workpiece and a template image of the target workpiece, and compare the to-be-detected image with the template image to obtain a differential image;
a second processing module 2202, configured to input the to-be-detected image and the differential image to a defect detection model, to perform the following processing: extracting a target image feature based on the to-be-detected image and the differential image; and performing defect detection on the to-be-detected image based on the target image feature to obtain defect detection bounding box information in the to-be-detected image;
a third processing module 2203, configured to locate a defect region in the differential image, and determine a first detection result of the target workpiece based on the defect region; and
a fourth processing module 2204, configured to determine a second detection result of the target workpiece based on the defect detection bounding box information and the first detection result.

Further, the second processing module 2202 is configured to: extract a first image feature from the to-be-detected image; extract a second image feature from the differential image; and fuse the first image feature and the second image feature to obtain the target image feature.

In a possible implementation, the second processing module 2202 is configured to:
replicate data of each channel in the differential image until a quantity of channels of a differential image obtained through replication is equal to a quantity of channels of the to-be-detected image; and
separately input the to-be-detected image and the differential image obtained through replication to the defect detection model, the to-be-detected image and the differential image obtained through replication sharing a same feature extraction module in the defect detection model.

In a possible implementation, the second processing module 2202 is configured to:
sequentially perform convolution on the to-be-detected image in a plurality of stages,
each stage including at least one convolutional branch, and each convolutional branch being configured to perform convolution for a plurality of times;
a new convolutional branch being added upon entering a next stage from a current stage, and a resolution of the new convolutional branch being less than that of any existing convolutional branch in the current stage; and
a feature inputted to any convolutional branch in the current stage being obtained by fusing features outputted by all convolutional branches in a previous stage;
fuse initial convolutional features outputted by convolutional branches in a last stage, to obtain a first target convolutional feature; and
downsample the first target convolutional feature to obtain the first image feature.

In a possible implementation, the second processing module 2202 is configured to:
fuse a plurality of initial convolutional features to obtain a fusion feature;
for each of a plurality of convolutional branches in the last stage, perform, on the fusion feature, convolution with a resolution the same as that of the convolutional branch, to obtain a second target convolutional feature of the convolutional branch; and
fuse a plurality of second target convolutional features to obtain the first target convolutional feature.

In a possible implementation, the second processing module 2202 is configured to:
concatenate a feature value of each pixel in the first image feature with a feature value of a corresponding pixel in the second image feature to obtain a third image feature;
reduce dimensionality of the third image feature to obtain a fourth image feature; and
activate the fourth image feature to obtain the target image feature.

In a possible implementation, the defect detection model includes a plurality of network heads, a local region feature extractor connected to each network head, and an RPN, and the second processing module 2202 is configured to:
input the target image feature to the RPN for region extraction, to obtain reference detection bounding box coordinates;
for the first network head,
input the reference detection bounding box coordinates and the target image feature to a local region feature extractor connected to the first network head for pooling, input an obtained pooling feature to the first network head for defect detection, and output defect detection bounding box coordinates;
for each of remaining network heads,
input defect detection bounding box coordinates outputted by a previous network head and the target image feature to a local region feature extractor connected to the network head for pooling, input an obtained pooling feature to the network head for defect detection, and output defect detection bounding box coordinates; and
determine defect detection bounding box coordinates outputted by a last network head as the defect detection bounding box information.

In a possible implementation, the defect detection bounding box information includes defect detection bounding box coordinates, a detection bounding box confidence probability, and a target defect category, and the fourth processing module 2204 is configured to:
when the first detection result indicates that the target workpiece has no defect, obtain a preset confidence probability threshold and a preset area threshold that correspond to the target defect category;
determine a defect area based on the defect detection bounding box coordinates, and determining a first magnitude relationship between the defect area and the preset area threshold, and a second magnitude relationship between the detection bounding box confidence probability and the preset confidence probability threshold; and
determine the second detection result based on the first magnitude relationship and the second magnitude relationship.

In a possible implementation, the fourth processing module 2204 is further configured to:
when the first detection result indicates that the target workpiece has a defect, determine that the second detection result is that the target workpiece has a defect.

In a possible implementation, the first processing module 220 is configured to:
determine a transformation parameter between the to-be-detected image and the template image;
align a target workpiece displayed in the template image with a target workpiece displayed in the to-be-detected image based on the transformation parameter, to obtain an aligned to-be-detected image;
compare the aligned to-be-detected image with the template image to obtain an initial differential image; and
filter the initial differential image to obtain the differential image.

In a possible implementation, the first processing module 2201 is configured to:
determine a current window region in the to-be-detected image by using a sliding window;
calculate a correlation coefficient between an image in the current window region and an image in a corresponding window region in the template image;
determine a target region in the to-be-detected image based on a correlation coefficient of each window region;
determine a transformation matrix needed for transforming the target region into an aligned region in the template image; and
determine an inverse matrix of the transformation matrix as the transformation parameter.

Further, the second processing module 2202 is configured to:
concatenate the to-be-detected image and the differential image to obtain a concatenated image; and
input the concatenated image to the defect detection model to extract the target image feature.

In a possible implementation, the defect detection apparatus further includes a first training module, and the first training module is configured to:
obtain a training image of the target workpiece, the training image being labeled with a corresponding defect category label;
compare the training image with the template image to obtain a sample differential image;
input the training image and the sample differential image to the defect detection model to obtain sample detection bounding box information in the training image, the sample detection bounding box information including a sample defect category of the target workpiece;
determine an initial classification loss based on the sample defect category and the defect category label;
adjust the initial classification loss based on a preset first adjustment parameter and a preset second adjustment parameter to obtain a target classification loss, the first adjustment parameter being related to quantities of positive samples and negative samples corresponding to the defect category label, and the second adjustment parameter being related to a classification difficulty level corresponding to the defect category label; and
train the defect detection model based on the target classification loss.

The defect detection apparatus 2200 and the defect detection method are based on a same inventive concept. A to-be-detected image of a target workpiece is compared with a template image to obtain a differential image, where the differential image can provide visual difference information of the target workpiece. Then the to-be-detected image and the differential image are inputted to a defect detection model, to introduce difference information into the model, and help improve accuracy of feature extraction performed by the model. Then a target image feature is extracted, and defect detection is performed on the to-be-detected image based on the target image feature to obtain defect detection bounding box information in the to-be-detected image. A feature related to a defect region in the to-be-detected image is highlighted by using a feature, in the target image feature, that corresponds to the differential image. This helps improve a capability of detecting, by the model, a defect category that has not been learned due to lack of a training sample, to improve accuracy of the defect detection bounding box information. A first detection result of the target workpiece is determined based on the defect region located by using the differential image, and a second detection result of the target workpiece is determined based on both the first detection result and the defect detection bounding box information. To be specific, a feature obtained through a plurality of times of comparison is used based on defect detection performed by using a deep learning algorithm. High visibility of the feature obtained through comparison can visually assist in defect detection, to effectively improve accuracy of defect detection and reduce dependency on a training sample.

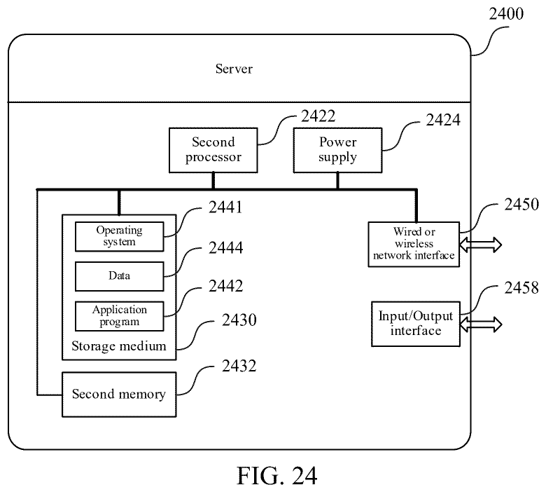

An electronic device provided in embodiments of this disclosure to perform the foregoing defect detection method may be a terminal. FIG. 23 is a block diagram of a partial structure of a terminal according to an embodiment of this disclosure. The terminal includes the following components: a camera assembly 2310, a memory 2320, an input unit 2330, a display unit 2340, a sensor 2350, an audio circuit 2360, a Wi-Fi module 2370, processing circuitry such as a processor 2380, a power supply 2390, and the like. In some examples, the memory 2320 includes a non-transitory computer-readable storage medium configured to store computer-executable instructions. A person skilled in the art may understand that the structure of the terminal shown in FIG. 23 does not constitute a limitation on the terminal. The terminal may include more or fewer components than those shown in the figure, or some components may be combined, or different component layouts may be used.

In this embodiment, the processor 2380 included in the terminal may perform the defect detection method in the foregoing embodiments.

An electronic device provided in embodiments of this disclosure to perform the foregoing defect detection method may alternatively be a server. FIG. 24 is a block diagram of a partial structure of a server according to embodiment of this disclosure. The server 2400 may vary greatly due to different configurations or performance, and may include processing circuitry such as one or more central processing units (CPUs) 2422 (for example, one or more processors), a memory 2432, and one or more storage media 2430 (for example, one or more mass storage apparatuses) that store an application program 2442 or data 2444. The memory 2432 and the storage medium 2430 may perform transient storage or persistent storage. In some examples, the storage medium 2430 includes a non-transitory computer-readable storage medium configured to store computer-executable instructions. A program (or computer-executable instructions) stored in the storage medium 2430 (e.g., the non-transitory computer-readable storage medium) may include one or more modules (not shown in the figure), and each module may include a series of instruction operations on the server 2400. Further, the CPU 2422 may be configured to communicate with the storage medium 2430, and perform, on the server 2400, a series of instruction operations in the storage medium 2430.

The server 2400 may further include one or more power supplies 2424, one or more wired or wireless network interfaces 2450, one or more input/output interfaces 2458, and/or one or more operating systems 2441, for example, Windows Server™, Mac OS X™, Unix™, Linux™, or FreeBSD™.

The processor in the server 2400 may be configured to perform the defect detection method.

An embodiment of this disclosure further provides a non-transitory computer-readable storage medium. The non-transitory computer-readable storage medium is configured to store program code (such as executable instructions). The program code is configured to perform the defect detection method in the foregoing embodiments.

An embodiment of this disclosure further provides a computer program product. The computer program product includes a computer program (such as executable instructions). The computer program is stored in a non-transitory computer-readable storage medium. Processing circuitry (e.g., a processor) of a computer device reads the computer program from the non-transitory computer-readable storage medium, and the processor executes the computer program, to enable the computer device to perform the foregoing defect detection method.

In the specification and accompanying drawings of this disclosure, the terms “first”, “second”, “third”, “fourth”, and so on (if existent) are intended to distinguish between similar objects but do not necessarily indicate a specific order or sequence. Data used in this way is exchangeable in a proper case, to describe the embodiments of this disclosure. For example, the embodiments can be implemented in an order different from the order shown or described herein. In addition, the terms “include”, “have”, and any variants thereof are intended to cover a non-exclusive inclusion. For example, a process, method, system, product, or apparatus that includes a list of operations or units is not necessarily limited to those expressly listed operations or units, but may include other operations or units that are not expressly listed or are inherent to the process, method, product, or apparatus.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive. The term “and/or” is configured for describing an association between associated objects and representing that three associations may exist. For example, “A and/or B” may indicate that only A exists, only B exists, and both A and B exist, where A and B may be singular or plural. The character “/” usually indicates an “or” relationship between associated objects.

In the description of the embodiments of this disclosure, “a plurality of (or multiple)” means two or more; “greater than”, “less than”, “exceed”, and the like are understood as excluding a number itself, and “above”, “below”, “within”, and the like are understood as including a number itself.

In the several embodiments provided in this disclosure, the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the shown or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and components shown as units may or may not be physical units, that is, may be located in one position, or may be distributed on a plurality of network units. Some or all of the units may be selected according to actual requirements to achieve the objectives of the solutions of the embodiments.

In addition, functional units in the embodiments of this disclosure may be integrated into one processing unit, or each unit may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this disclosure essentially, or the part contributing to the related technology, or all or some of the technical solutions may be implemented in a form of a software product. The computer software product is stored in a storage medium and includes several instructions for indicating a computer apparatus (which may be a personal computer, a server, or a network apparatus) to perform all or some of the operations of the methods described in the embodiments of this disclosure. The foregoing storage medium includes: any medium that can store program code, such as a USB flash disk, a removable hard disk, a read-only memory (ROM), a random access memory (RAM), a magnetic disk, or an optical disc.

The implementations provided in the embodiments of this disclosure may be combined in any manners to achieve different technical effects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing describes implementations based on various embodiments of this disclosure, and the scope of this disclosure is not limited to the foregoing implementations. A person skilled in the art may make various modifications, variations, or replacements without departing from the spirit of this disclosure. These modifications, variations, or replacements are all included in the scope of this disclosure.

What is claimed is:

1. A defect detection method, comprising:
obtaining a to-be-detected image of a target workpiece and a template image of the target workpiece;
obtaining a differential image based on a difference between the to-be-detected image and the template image;
performing, by processing circuitry, defect detection based on application of a defect detection model to the to-be-detected image and the differential image to obtain defect detection bounding box information in the to-be-detected image;
determining, by the processing circuitry, defect region information in the differential image;
determining a first detection result of the target workpiece based on the defect region information; and
determining a second detection result of the target workpiece based on the defect detection bounding box information and the first detection result.

2. The defect detection method according to claim 1, wherein the performing the defect detection comprises:
extracting a first image feature from the to-be-detected image;
extracting a second image feature from the differential image; and
fusing the first image feature and the second image feature to obtain a target image feature.

3. The defect detection method according to claim 2, wherein the application of the detect detection model to the to-be-detected image and the differential image comprises:
obtaining an expanded differential image based on replicating data of the differential image, a quantity of channels of the expanded differential image being equal to a quantity of channels of the to-be-detected image, and a quantity of channels of the differential image being less than the quantity of channels of the to-be-detected image; and
separately inputting the to-be-detected image and the expanded differential image to the defect detection model.

4. The defect detection method according to claim 2, wherein the application of the defect detection model to the to-be-detected image and the differential image comprises:
performing convolution in a plurality of stages,
each stage including at least one convolutional branch,
each convolutional branch being configured to perform convolution for a plurality of times,
a first stage of the plurality of stages including one convolutional branch taking the to-be-detected image as input;
for each stage of the plurality of stages after the first stage,
a new convolutional branch being added upon entering a next stage from the respective stage,
a resolution of the new convolutional branch being less than that of any existing convolutional branch in the respective stage, and
a feature inputted to each convolutional branch in the respective stage being obtained by fusing features outputted by all convolutional branches in a previous stage;
fusing initial convolutional features outputted by the convolutional branches in a last stage of the plurality of stages, to obtain a first target convolutional feature; and
downsampling the first target convolutional feature to obtain the first image feature.

5. The defect detection method according to claim 4, wherein the fusing the initial convolutional features comprises:
fusing the initial convolutional features to obtain a fusion feature;
for each of the convolutional branches in the last stage, performing, on the fusion feature, convolution with a resolution same as that of the respective convolutional branch, to obtain a second target convolutional feature of the respective convolutional branch; and
fusing the second target convolutional features of the convolutional branches in the last stage to obtain the first target convolutional feature.

6. The defect detection method according to claim 2, wherein the fusing the first image feature and the second image feature comprises:
concatenating a feature value of each pixel in the first image feature with a feature value of a corresponding pixel in the second image feature to obtain a third image feature;
reducing a dimension of the third image feature to obtain a fourth image feature; and
activating the fourth image feature to obtain the target image feature.

7. The defect detection method according to claim 1, wherein
the defect detection model includes:
N network heads, N being a positive integer greater than one;
a local region feature extractor connected to each network head; and
a region proposal network (RPN), and
the performing the defect detection includes:
extracting a target image feature based on the to-be-detected image and the differential image;
inputting the target image feature to the RPN for region extraction, to obtain reference detection bounding box coordinates;
for a first network head of the N network heads,
inputting the reference detection bounding box coordinates and the target image feature to a first local region feature extractor connected to the first network head for pooling,
inputting an obtained pooling feature from the first local region feature extractor to the first network head for defect detection, and
outputting a first set of defect detection bounding box coordinates from the first network head;
for each of n-th network heads of the N network heads, n ranging from two to N,
inputting the (n−1)-th set defect detection bounding box coordinates outputted by a previous network head and the target image feature to an n-th local region feature extractor connected to the n-th network head for pooling,
inputting an obtained pooling feature from the n-th local region feature extractor to the n-th network head for defect detection, and
outputting an n-th set of defect detection bounding box coordinates from the n-th network head; and
determining the N-th set of defect detection bounding box coordinates outputted by the N-th network head as the defect detection bounding box information.

8. The defect detection method according to claim 1, wherein
the defect detection bounding box information includes:
defect detection bounding box coordinates of a bounding box;
a detection bounding box confidence probability associated with the bounding box; and
a target defect category associated with the bounding box, and
the determining the second detection result includes:
when the first detection result indicates that the target workpiece has no defect, obtaining a preset confidence probability threshold and a preset area threshold that correspond to the target defect category;
determining a defect area based on the defect detection bounding box coordinates;
determining a first magnitude relationship between the defect area and the preset area threshold;
determining a second magnitude relationship between the detection bounding box confidence probability and the preset confidence probability threshold; and
determining the second detection result based on the first magnitude relationship and the second magnitude relationship.

9. The defect detection method according to claim 8, further comprising:
when the first detection result indicates that the target workpiece has a defect, determining that the second detection result is that the target workpiece has a defect.

10. The defect detection method according to claim 1, wherein the obtaining the differential image comprises:
determining a transformation parameter between the to-be-detected image and the template image;
obtain an aligned to-be-detected image based on the transformation parameter for aligning the target workpiece displayed in the template image with the target workpiece displayed in the aligned to-be-detected image;
comparing the aligned to-be-detected image with the template image to obtain an initial differential image; and
filtering the initial differential image to obtain the differential image.

11. The defect detection method according to claim 10, wherein the determining the transformation parameter comprises:
determining a current window region in the to-be-detected image by using a sliding window;
calculating a correlation coefficient between an image in the current window region and an image in a corresponding window region in the template image;
determining a target region in the to-be-detected image based on a correlation coefficient of each window region;
determining a transformation matrix for transforming the target region into an aligned region in the template image; and
determining an inverse matrix of the transformation matrix as the transformation parameter.

12. The defect detection method according to claim 1, wherein the performing the defect detection comprises:
concatenating the to-be-detected image and the differential image to obtain a concatenated image; and
extracting a target image feature based on application of a feature extraction part of the defect detection model to the concatenated image.

13. The defect detection method according to claim 1, further comprising:
obtaining a training image of the target workpiece, the training image being labeled with a corresponding defect category label;
obtaining a sample differential image based on a difference between the training image and the template image;
inputting the training image and the sample differential image to the defect detection model to obtain sample detection bounding box information in the training image, the sample detection bounding box information including a sample defect category of the target workpiece;
determining an initial classification loss based on the sample defect category and the defect category label;
adjusting the initial classification loss based on a preset first adjustment parameter and a preset second adjustment parameter to obtain a target classification loss, the first adjustment parameter being related to quantities of positive samples and negative samples corresponding to the defect category label, and the second adjustment parameter being related to a classification difficulty level corresponding to the defect category label; and
training the defect detection model based on the target classification loss.

14. A defect detection apparatus, comprising:
processing circuitry configured to:
obtain a to-be-detected image of a target workpiece and a template image of the target workpiece;
obtain a differential image based on a difference between the to-be-detected image and the template image;
perform defect detection based on application of a defect detection model to the to-be-detected image and the differential image to obtain defect detection bounding box information in the to-be-detected image;
determine defect region information in the differential image;
determine a first detection result of the target workpiece based on the defect region information; and
determine a second detection result of the target workpiece based on the defect detection bounding box information and the first detection result.

15. The defect detection apparatus according to claim 14, wherein the processing circuitry is configured to:
extract a first image feature from the to-be-detected image;
extract a second image feature from the differential image; and
fuse the first image feature and the second image feature to obtain a target image feature.

16. The defect detection apparatus according to claim 15, wherein the processing circuitry is configured to:
obtain an expanded differential image based on replicating data of the differential image, a quantity of channels of the expanded differential image being equal to a quantity of channels of the to-be-detected image, and a quantity of channels of the differential image being less than the quantity of channels of the to-be-detected image; and
separately input the to-be-detected image and the expanded differential image to the defect detection model.

17. The defect detection apparatus according to claim 15, wherein the processing circuitry is configured to:
perform convolution in a plurality of stages,
each stage including at least one convolutional branch,
each convolutional branch being configured to perform convolution for a plurality of times,
a first stage of the plurality of stages including one convolutional branch taking the to-be-detected image as input;
for each stage of the plurality of stages after the first stage,
a new convolutional branch being added upon entering a next stage from the respective stage,
a resolution of the new convolutional branch being less than that of any existing convolutional branch in the respective stage, and
a feature inputted to each convolutional branch in the respective stage being obtained by fusing features outputted by all convolutional branches in a previous stage;
fuse initial convolutional features outputted by the convolutional branches in a last stage of the plurality of stages, to obtain a first target convolutional feature; and
downsample the first target convolutional feature to obtain the first image feature.

18. The defect detection apparatus according to claim 14, wherein
the defect detection model includes:
N network heads, N being a positive integer greater than 1;
a local region feature extractor connected to each network head; and
a region proposal network (RPN), and
the processing circuitry is configured to:
extract a target image feature based on the to-be-detected image and the differential image;
input the target image feature to the RPN for region extraction, to obtain reference detection bounding box coordinates;
for a first network head of the N network heads,
input the reference detection bounding box coordinates and the target image feature to a first local region feature extractor connected to the first network head for pooling,
input an obtained pooling feature from the first local region feature extractor to the first network head for defect detection, and
output a first set of defect detection bounding box coordinates from the first network head;
for each of n-th network heads of the N network heads, n ranging from two to N,
input the (n−1)-th set defect detection bounding box coordinates outputted by a previous network head and the target image feature to an n-th local region feature extractor connected to the n-th network head for pooling,
input an obtained pooling feature from the n-th local region feature extractor to the n-th network head for defect detection, and
output an n-th set of defect detection bounding box coordinates from the n-th network head; and
determine the N-th set of defect detection bounding box coordinates outputted by the N-th network head as the defect detection bounding box information.

19. The defect detection apparatus according to claim 14, wherein
the defect detection bounding box information includes:
defect detection bounding box coordinates of a bounding box;
a detection bounding box confidence probability associated with the bounding box; and
a target defect category associated with the bounding box, and
the processing circuitry is configured to:
when the first detection result indicates that the target workpiece has no defect, obtain a preset confidence probability threshold and a preset area threshold that correspond to the target defect category;
determine a defect area based on the defect detection bounding box coordinates;
determine a first magnitude relationship between the defect area and the preset area threshold;
determine a second magnitude relationship between the detection bounding box confidence probability and the preset confidence probability threshold; and
determine the second detection result based on the first magnitude relationship and the second magnitude relationship.

20. A non-transitory computer-readable storage medium storing instructions, which when executed by a processor, cause the processor to perform a dialogue processing method comprising:
obtaining a to-be-detected image of a target workpiece and a template image of the target workpiece;
obtaining a differential image based on a difference between the to-be-detected image and the template image;
performing defect detection based on application of a defect detection model to the to-be-detected image and the differential image to obtain defect detection bounding box information in the to-be-detected image;
determining defect region information in the differential image;
determining a first detection result of the target workpiece based on the defect region information; and
determining a second detection result of the target workpiece based on the defect detection bounding box information and the first detection result.
